(19) United States
(12) Patent Application Publication
(10) Pub. No.: US 2011/0040669 A1
(43) Pub. Date: Feb. 17, 2011

(54) AUTOMATED SPREAD TRADING SYSTEM

(75) Inventors: Darren Lee, London (GB); Richard Banks, London (GB); David Anderson, Cowdenbeath (GB)

Correspondence Address: BAINWOOD HUANG & ASSOCIATES LLC, 2 CONNECTOR ROAD, WESTBOROUGH, MA, 01581, US

(73) Assignee: Darren Lee, London (GB)

(21) Appl. No.: 12/857,985

(22) Filed: Aug. 17, 2010

Related U.S. Application Data
(60) Provisional application No. 61/234,490, filed on Aug. 17, 2009.

(51) Int. Cl. G06Q 40/00

(52) U.S. Cl. 705/37

(57) ABSTRACT

An automated spread trading terminal receives from a user a selection of a spread trade indicative of a set of trading contracts defined in relation to the spread trade, and transmits to an electronic trading exchange a first set of messages including an order message such that an initial set of working orders corresponding to one of the trading contracts are rendered operative in the electronic trading exchange. The terminal receives from the electronic trading exchange a first fill confirmation message confirming the partial completion of a first working order in the initial set of working orders, and current market data indicating quantities of current bids and/or offers in relation to the trading contracts. in response to the first fill confirmation message, the terminal transmits to the electronic trading exchange a second set of messages such that a completing set of working orders are rendered operative in the electronic trading exchange. A quantity is reduced on order at a given price level from a first non-zero quantity to a second non-zero quantity for a trading contract on the basis of a bid or offer quantity in the current market data.

### BACKGROUND

The present invention relates to an automated spread trading system designed to allow a user to automatically perform spread trades in one or more electronic trading exchange systems.

Systems for electronically trading contracts exist where a plurality of terminals connect to an electronic trading exchange system (or several electronic trading exchange systems) in order to receive data relating to contracts and transmit and receive data relating to orders for these contracts. Users controlling the terminals are presented with a graphical user interface through which the market (i.e. other orders and trades) for a contract or contracts can be viewed, and desired contracts can be selected in order to request orders to buy or sell these contracts. The terminals communicate with an electronic trading exchange system in order to execute the orders requested, and display the results of the execution of the orders.

Users may execute a spread trade consisting of a number of orders for a number of different contracts on these terminals to be executed simultaneously by using the graphical user interface to request an order for each contract of which the spread trade is to be comprised. However a user will find it difficult to keep track of both market changes relating to the orders he wishes to place and changes relating to the orders themselves.

United States patent application publication number US 2003/2020167 A1 describes a terminal for automatic spread trading. A spread data feed is generated in response to market data feeds and using spread parameters entered by a user. The spread data feed is displayed via a graphical user interface to the user, who can request that spread trades be performed via this interface. Orders will then be automatically executed at an electronic trading exchange system and managed in order to achieve, or attempt to achieve, the spread price required by the user, or better.

United States patent application publication number US 2006/0271468 A1 describes a system for electronically inputting, monitoring and trading spread trades. A terminal provides a dynamic display of electronic trading information for trading spreads and allows the user to input spreads composed of multiple orders via a user interface. One or more orders relating to an entered spread trade can then be automatically executed by the terminal on one or more electronic trading exchange systems.

The prior art thus allows users to select and enter a spread trade, orders for which are then executed automatically. Changes in trading markets can happen very quickly however and it may be the case that once a spread trade has been executed using one of the terminals described in the prior art the markets for the contracts involved in the spread trade fluctuate rapidly. Using the terminals described in the prior art a user may be unable to react quickly enough to many of the rapid changes that occur in trading markets, hence many trading opportunities may be missed.

The present invention improves upon the prior art by providing an automated spread trading system designed to allow a user to automatically perform spread trades at an electronic trading exchange system, that provides a number of features that allow a user to execute a spread trade at a price consistent with a spread price required by the user, or better, and that provides a number of features that allow the user to gain a processing advantage over other terminals.

### SUMMARY

In accordance with one aspect of the invention, there is provided a computer-implemented method for generating and transmitting, via a data communications network, messages related to a spread trade, said method comprising:
in a computer process, receiving from a user a selection of a spread trade indicative of a set of trading contracts defined in relation to the spread trade;
in a computer process, transmitting to at least one electronic trading exchange a first set of one or more messages, including one or more order messages relating to said user selection such that an initial set of one or more working orders, each corresponding to one of the trading contracts defined in relation to the selected spread trade, are rendered operative in the at least one electronic trading exchange;
in a computer process, receiving from the at least one electronic trading exchange a first fill confirmation message confirming the at least partial completion of a first working order in said initial set of working orders;
in a computer process, receiving from an electronic trading exchange current market data indicating quantities of current bids and/or offers in relation to one or more of the trading contracts defined in relation to the spread trade;
in a computer process, in response to receiving said first fill confirmation message, transmitting to at least one of the at least one electronic trading exchanges a second set of one or more messages, including one or more order messages and/or order modification messages, relating to said user selection such that a completing set of one or more working orders, each corresponding to one of the trading contracts defined in relation to the selected spread trade, are rendered operative in the at least one of the at least one electronic trading exchange, the completing set of working orders relating to one or more trading contracts including one or more trading contracts other than the trading contract in relation to which said first fill confirmation message has been received,
wherein said method comprises reducing a quantity on order at a given price level, from a first non-zero quantity to a second non-zero quantity, for a trading contract in said completing set of one or more working orders on the basis of at least one bid or offer quantity in said current market data.

In accordance with this aspect of the invention, after a spread trade has been at least partially filled, a set of one or more completing orders can be triggered, and execution advantage can be gained whilst reducing risk—as a bid or offer quantity relating to said given price level in said current market data tends to indicate a risk of loss of the opportunity to trade at the given price level, the quantity on offer at the given price level can be reduced automatically, e.g. by selling out at a worse price level, to leave only some of the initial quantity on order. Hence, an upside can be maintained whilst reducing the downside risk.

In accordance with a further aspect of the invention, there is provided a computer-implemented method for generating and transmitting, via a data communications network, messages related to a spread trade, said method comprising:
in a computer process, receiving from a user a first selection of a spread trade indicative of a set of trading contracts defined in relation to a first spread trade;
in a computer process, transmitting to at least one electronic trading exchange a first set of one or more messages, including one or more order messages relating to said first selection such that an initial set of one or more working orders, each corresponding to one of the trading contracts defined in relation to said first spread trade are rendered operative in the at least one electronic trading exchange;
in a computer process, receiving from the at least one electronic trading exchange a first fill confirmation message confirming the at least partial completion of a first working order in said initial set of working orders;
in a computer process, in response to receiving said first fill confirmation message, transmitting to at least one of the at least one electronic trading exchanges a second set of one or more messages, including one or more order messages and/or order modification messages, relating to said first selection such that a completing set of one or more working orders, each corresponding to one of the trading contracts defined in relation to said first spread trade, are rendered operative in the at least one of the at least one electronic trading exchanges, the completing set of working orders relating to one or more trading contracts including one or more trading contracts other than the trading contract in relation to which said first fill confirmation message has been received,
in a computer process, receiving a second selection of a spread trade indicative of a set of trading contracts defined in relation to a second spread trade, and processing said second selection, said processing comprising transmitting to the at least one electronic trading exchange an order cancellation message or an order modification message, such that a first completing working order in said completing set of working orders is cancelled or modified in the at least one electronic trading exchange in response to detecting a correspondence between a trading contract being processed in said second selection and a trading contract being processed in said first selection.

In accordance with this aspect of the invention, a working order for completing one spread trade can be cancelled or modified as a result of detection of correspondence with another spread trade leg—hence a contract may be “internally traded” without need to actually trade on the electronic trading exchange in order to complete trading for a particular trading contract in a set of spread trades, or a part thereof.

In accordance with a yet further aspect of the invention, there is provided a computer-implemented method for generating and transmitting, via a data communications network, messages related to a spread trade, said method comprising:
in a computer process, receiving from a user a selection of a spread trade indicative of a set of trading contracts defined in relation to the spread trade;
in a computer process, receiving from an electronic trading exchange first price data indicating prices of current bids, offers and/or trades in relation to one or more of the trading contracts defined in relation to the spread trade;
in a computer process, in response to detecting that said first price data indicates that said prices of current bids, offers and/or trades satisfies a first threshold criterion, transmitting to at least one electronic trading exchange a first set of one or more messages, including one or more order messages relating to said user selection such that an initial set of one or more working orders, each corresponding to one of the trading contracts defined in relation to the selected spread trade are rendered operative in the at least one electronic trading exchange.

In this way, an order for a trading contract, or set of orders, can be automatically activated, or reactivated, only after waiting until the threshold criterion is satisfied, in order to avoid setting up working orders, or maintaining working orders, in the order matching system whilst there is a low chance that those working orders may be filled, thereby reducing data communications with the electronic trading exchange. These communications can be significant in view of any modifications that such working orders may require during the working order process, which can be regular, even whilst there is a low chance of the working orders being filled.

In accordance with a yet further aspect of the invention, there is provided a computer-implemented method for generating and transmitting, via a data communications network, messages related to a spread trade, said method comprising:
in a computer process, receiving from a user a selection of a spread trade indicative of a set of trading contracts defined in relation to the spread trade;
in a computer process, transmitting to at least one electronic trading exchange a first set of one or more messages, including one or more order messages relating to said user selection such that an initial set of one or more working orders, each corresponding to one of the trading contracts defined in relation to the selected spread trade are rendered operative in the at least one electronic trading exchange;
in a computer process, receiving from the at least one electronic trading exchange a first fill confirmation message confirming the at least partial completion of a first working order in said initial set of working orders;
in a computer process, in response to receiving said first fill confirmation message, transmitting to at least one of the at least one electronic trading exchanges a second set of one or more messages, including one or more order modification messages, relating to said user selection such that a completing set of one or more working orders, each corresponding to one of the trading contracts defined in relation to the selected spread trade, are rendered operative in the at least one of the at least one electronic trading exchanges, the order modification messages relating to said initial set of working orders.

This aspect provides a way of avoiding, or reducing, a “double-fill” risk, which is a risk associated with prior art methods in which a completing order is set up using a new order message. Often, using prior art methods, a corresponding initial order is cancelled only after the completing order is set up, thereby risking a “double-fill” of both one of the initial set of working orders and the corresponding completing working order. This risk is ameliorated using this aspect of the present invention, in which one or more of the initial set of working orders may be modified, typically by sending a price modification message, to form one or more of the completing working orders.

In accordance with a yet further aspect of the invention, there is provided a computer-implemented method for generating and transmitting, via a data communications network, messages related to a spread trade, said method comprising:
in a computer process, receiving from a user a selection of a spread trade indicative of a set of trading contracts defined in relation to the spread trade;
in a computer process, transmitting to at least one electronic trading exchange a first set of one or more messages, including one or more order messages relating to said user selection such that an initial set of one or more working orders, each corresponding to one of the trading contracts defined in relation to the selected spread trade, are rendered operative in the at least one electronic trading exchange;
in a computer process, receiving from the at least one electronic trading exchange a first fill confirmation message confirming the at least partial completion of a first working order in said initial set of working orders;
in a computer process, receiving from an electronic trading exchange current market data indicating quantities of current bids and/or offers in relation to one or more of the trading contracts defined in relation to the spread trade, the current market data including quantities of current bids and/or offers at a plurality of different price levels including a best price level and an off-best price level;
in a computer process, in response to receiving said first fill confirmation message, transmitting to at least one of the at least one electronic trading exchanges a second set of one or more messages, including one or more order messages and/or order modification messages, relating to said user selection such that a completing set of one or more working orders, each corresponding to one of the trading contracts defined in relation to the selected spread trade, are rendered operative in the at least one of the at least one electronic trading exchange, the completing set of working orders relating to one or more trading contracts including one or more trading contracts other than the trading contract in relation to which said first fill confirmation message has been received,
wherein a working order for a trading contract in said completing set of one or more working orders is controlled, by the transmission of messages to at least one of the at least one electronic trading exchanges, at least partly on the basis of both a quantity at said best price level and at a quantity at an off-best price level for said trading contract.

In accordance with this aspect of the invention, after a spread trade has been at least partially filled, a set of one or more completing orders can be triggered, and execution advantage can be gained whilst reducing risk—as a bid or offer quantity at a best price level and at a quantity at an off-best price level for a trading contract tends to indicate a risk of loss of the opportunity to trade at, or near to, both the best price level and at, or near to, the off-best price level, the working order can be changed automatically, e.g. by selling out at a currently available price level. This thus reduces the downside risk, taking account of quantities currently available not only the best price level but also at an off-best price level.

In accordance with a yet further aspect of the invention, there is provided a computer-implemented method for generating and transmitting, via a data communications network, messages related to a spread trade, said method comprising:
in a computer process, receiving from a user:
   a selection of a spread trade indicative of a set of trading contracts defined in relation to the selected spread trade;
   a selection of a trading contract, said selected trading contract being one of the set of trading contracts defined in relation to the selected spread trade
   an indication of a price level at which said selected trading contract is to be traded;
in a computer process, transmitting to at least one electronic trading exchange a message relating to said selected trading contract, said message rendering operative, in the at least one electronic trading exchange, an order relating to said selected trading contract at the indicated price level;
in a computer process, receiving from the at least one electronic trading exchange a first fill confirmation message confirming the at least partial completion of said order relating to said selected trading contract;
in a computer process, transmitting to at least one of the at least one electronic trading exchanges a set of one or more messages, including one or more order messages and/or order modification messages, relating to said selected spread trade such that a completing set of one or more working orders, each corresponding to one of the trading contracts defined in relation to the selected spread trade, are rendered operative in the at least one of the at least one electronic trading exchanges, the completing set of working orders relating to one or more trading contracts including one or more trading contracts other than said selected trading contract.

In accordance with this aspect of the invention, a user can set up a spread trade in an entirely new way. The user can select, rather than to set up a spread trade using a desired conglomerated spread trade price, to set up an order relating to an individual selected trading contract which is to form part of a spread trade, the order relating to the individual trading contract being at an indicated price level for that contract alone. After the order has been filled at the indicated price level, a set of one or more completing orders can be triggered, in order to initiate a spread trade at a time when the trading contract is available at the indicated price level.

Further aspects of the invention provide a computer-readable medium comprising code capable of causing a computer system to conduct a computer-implemented method for generating and transmitting, via a data communications network, messages related to a spread trade, in accordance with the above aspects of the invention.

Further features and advantages of the invention will become apparent from the following description of preferred embodiments of the invention, given by way of example only, which is made with reference to the accompanying drawings.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1a schematically illustrates the principle components and communication links of a system for performing automated spread trading according to different embodiments of the present invention.

FIG. 1b illustrates the steps performed to set up a spread trade and then instruct the AST terminal 100 to transmit orders relating to the spread trade to the electronic trading exchange 122 using a graphical user interface.

FIG. 2 illustrates the steps performed by the spreader component 108 in order to execute an initial set of working orders for a new spread trade after a new spread trade has been activated.

FIG. 3 illustrates the steps performed by the hedger component 110 in order to fill a hedge order for a leg of a spread trade where that hedge order belongs to the completing set of orders of the spread trade, after one of the working orders in the initial set of working orders of the spread trade has been filled at a price consistent with the spread order price (or better), recent trade data and current market data known to the spreader 108.

FIG. 4 illustrates an alternative set of steps performed by the hedger component 110 in order to create or convert an order or shared order for a new hedge order in step 308 of FIG. 3 when the ‘Queue Saving’ feature of the AST terminal 100 is enabled.

FIG. 5 shows the steps that may be performed by either the spreader 108, or the hedger 110, if either of these components requests to modify the price of a shared order in step 206 or step 310, respectively.

FIG. 6 illustrates steps performed by the hedger component 110 in step 307 of FIG. 3 in order to process ‘Internal Fills’ when a new hedge order is requested, when this feature has been enabled.

FIG. 7 illustrates steps performed by the spreader component 108 for a working leg so as to suspend or re-activate that working leg according a second threshold criterion or first threshold criterion, respectively, such as according to the current market data and recent trade data known to the spreader 108 from step 202.

FIG. 8a illustrates the steps that are performed by the spreader 108 if the ‘Speculate’ feature is enabled in order to calculate the price of a working order or orders (i.e. orders or orders in the initial set of working orders) of a spread trade.

FIG. 8b illustrates the steps that are performed by the spreader 108 if the ‘Speculate’ feature is enabled in order to calculate the price of a working order or orders (i.e. orders or orders in the initial set of working orders) of a spread trade.

FIG. 9a illustrates the steps that are performed by the spreader 108 when the ‘Lean’ feature is enabled for a leg of a spread trade, where the spreader 108 is leaning on the current highest bid price of the contract associated with the leg in order to calculate the price of a working order (or orders).

FIG. 9b illustrates the steps that are performed by the spreader 108 when the ‘Lean’ feature is enabled for a leg of a spread trade, where the spreader 108 is leaning on the current lowest offer price of the contract associated with the leg in order to calculate the price of a working order (or orders).

FIG. 10 illustrates the steps performed by the spreader 108 in order to execute a ‘Manual Order’.

FIG. 11 illustrates the steps performed by the spreader 108 in order to execute a spread trade created using an ‘At Best Spread Order’ ticket.

FIG. 12 shows an exemplary screenshot of the user interface of the system that allows the user to select the contracts of which a new spread template will be comprised.

FIG. 13 shows an exemplary screenshot of the user interface of the system that allows the user to select a spread template and set several parameters relating to the spread template.

FIG. 14 shows an exemplary screenshot of the user interface of the system that allows the user to select a leg of a spread template and set several parameters relating to the leg of the spread template.

FIG. 15 shows an exemplary screenshot of how the user creates a new ticket from a selected spread template 1000 by opening a ‘menu’ listing new ticket types 1002.

FIGS. 16a, 16b and 16c show exemplary screenshots of a ticket window for a standard spread trade.

FIG. 17 shows an exemplary screenshot of a ‘Manual Order’ ticket window.

FIG. 18 shows an exemplary screenshot of an ‘At Best Spread Order’ ticket window.

FIG. 19 shows an exemplary screenshot of a spread order list window.

FIG. 20 shows an exemplary screenshot of a hedge order list window.

### DETAILED DESCRIPTION

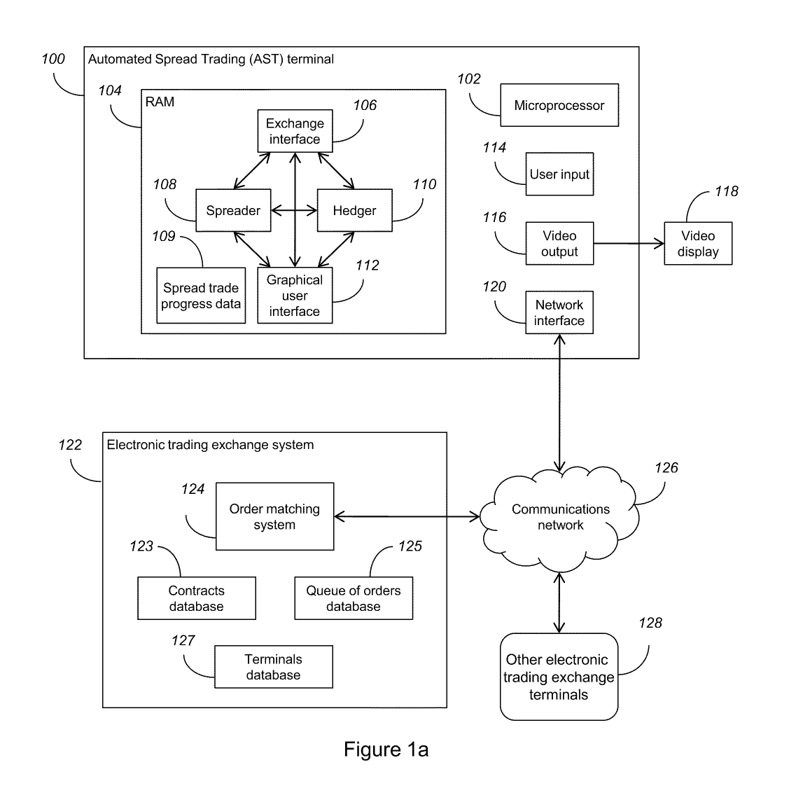

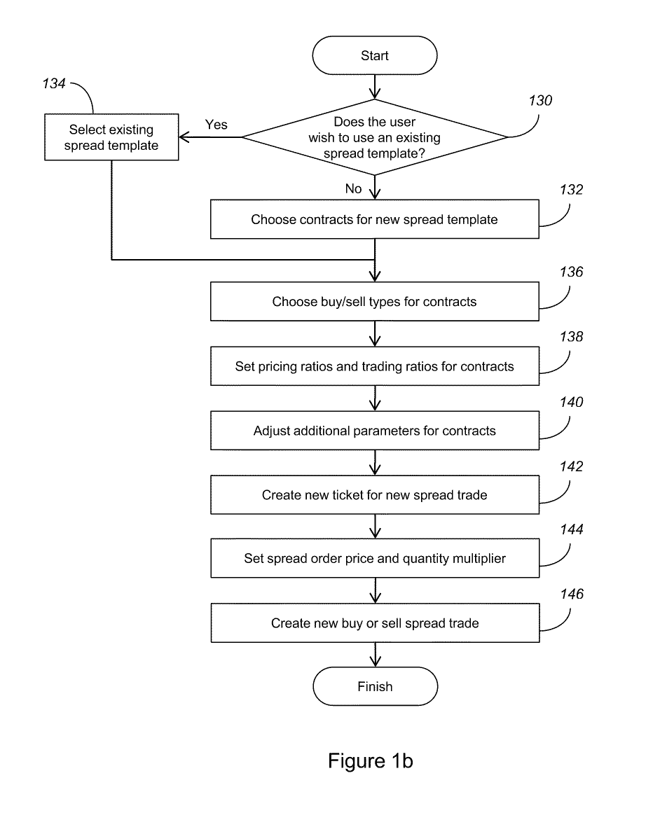

FIG. 1a schematically illustrates the principle components and communication links of a system for performing automated spread trading according to different embodiments of the present invention.

An Automated Spread Trading (AST) terminal 100 may be a general purpose computer such as a desktop personal computer, or other type of computing device such as a bespoke trading terminal, a smartphone, etc. The AST terminal 100 in this embodiment includes a microprocessor 102 that processes instructions in the form of electronic signals stored in a random access memory (RAM) 104 that have been loaded from a computer-readable medium such as a hard disk (not illustrated). These instructions are in the form of computer software, in the form of one or more programs that implement an exchange interface 106, a spreader component 108, a hedger component 110, and a graphical user interface component 112. The RAM 104 is also used by programs running on the microprocessor 102 as a means of storing and accessing data in the form of electronic signals where said data is used during execution of said programs, such as for example electronic signals relating to spread trade progress data 109 relating to spread trades performed by the spreader 108 and hedger 110. The terminal 100 also includes a video output device 116 that is able to render graphics produced by programs running on the microprocessor 102 and output these to a video display device 118, or a plurality of such video display devices 118. Programs running on the microprocessor 102 can process user input received via user input interface 114 for accepting user input from a user input device or devices (not shown) such as a mouse and/or computer keyboard. The AST terminal 100 also includes a network interface 120 such as a network card or a broadband modem that allows programs running on the microprocessor 102 to transmit and receive data over a data communications link via a communications network 126 such as the Internet, a private data communications network or a leased line in a public data communications network, to and from an electronic trading exchange system 122.

The electronic trading exchange system 122, which is an exemplary one of a plurality of different exchanges with which the AST terminal 100 is arranged to communicate with in order to conduct trades, includes a plurality of computing devices, for example server computers, which run order matching and other service applications, interconnected in order to provide a reliable distributed set of computing devices which cooperate to form the electronic trading exchange system 122.

The graphical user interface component 112 of the AST terminal 100 provides a graphical user interface (GUI) displayed via the video output component 116 on the video display 118 that allows a user to enter and control spread trades relating to a plurality of contracts with a user input device (or devices). The spreader component 108 and hedger component 110 perform so as to automatically submit and manage orders for contracts relating to user entered spread trades via an exchange interface 106. Information relating to the orders and spread trades managed by the spreader component 108 and hedger component 110 is stored in spread trade progress data 109 held in RAM 104, and may be either shared between the spreader component 108 and hedger component 110 or transferred between them when appropriate. The exchange interface 106 communicates via a communications network 126 with the electronic trading exchange system 122 or a plurality of such electronic trading exchange systems (not shown) in order to create orders, receive updates regarding orders, and modify orders for contracts submitted and managed by the spreader component 108 and hedger component 110, and also receives trading data from the electronic trading exchange system 122 (or systems) in relation to contracts that have been traded so that this information can be used by the spreader component 108 and/or hedger component 110 and/or can be displayed on the graphical user interface component 112.

The electronic trading exchange system 122 comprises an order matching system 124 for matching orders for contracts received from the AST terminal 100 and a plurality of other electronic trading exchange terminals 128. The electronic trading exchange system 122 may also comprise a queue of orders database 125 used to store information relating to received orders that have not yet been matched, a contracts data base 123 used to store information relating to the contracts that may be traded at the electronic trading exchange system 122, and a terminals database 127 used to store information relating to the trading terminals connected to the electronic trading exchange system such as the AST terminal 100 and the plurality of other electronic trading exchange terminals 128.

The plurality of other electronic trading exchange terminals 128 may include electronic trading exchange terminals which are programmed to operate according to the automated spread trade methods used by the AST terminal 100 in accordance with the present invention, and may include other electronic trading exchange terminals which need not operate according to the methods used by the AST terminal 100. Such other electronic trading exchange terminals may for example include terminals which operate according to an automated trading system provided by Trading Technologies, and may include manual order entry terminals that may be used to place individual orders that may or may not relate to spread trades. The electronic trading exchange system 122 provides data communications interfaces through which a plurality of users can trade contracts electronically by means of data communications, allowing many contracts to be traded by a large number of users. A contract could typically be a futures contract which is a contract to buy or sell a quantity of a particular commodity at a certain point in the future. A spread trade will typically relate to a combination of two or more of such contracts. A spread trade may for example involve buying a contract for crude oil and selling a contract for a petroleum product derived from crude oil such as gasoline.

In order to perform a trade on a particular contract, an electronic trading exchange terminal (e.g. one of AST terminal 100 or electronic trading exchange terminals 128) may transmit a request in the form of a data message relating to an order to the electronic trading exchange system 122 where that contract is traded. Each order data message may include a contract identifier that uniquely identifies the contract that is to be traded, a buy/sell type indicating whether the contract is to be bought (i.e. the order is a bid) or sold (i.e. the order is an offer), a price value indicating the price at which the contract is to be bought or sold, and a quantity value indicating the quantity to purchase or sell. The price of an order is identified in the data message according to a format determined by the electronic trading exchange system 122 and known to the exchange interface 106. In general the smallest possible change in any price is measured in terms of a standardised unit called a ‘tick’. The quantity of an order is also identified in the data message in terms of a standardised unit. In order to allow the electronic trading exchange system 122 to determine the terminal that has transmitted an order, the order message may also contain a unique terminal identifier. Each order message received by the electronic trading exchange system 122 is assigned a unique order identifier by the electronic trading exchange system 122. Upon receipt of a new order message the electronic trading exchange system 122 transmits a new order confirmation data message containing the unique identifier of the new order to the terminal that sent the order, as this is used by both the terminal and electronic trading exchange to identify the order in future communications.

The electronic trading exchange system 122 receives orders from a number of electronic trading exchange terminals 100, 128, and these are processed by an order matching system 124. The order matching system 124 stores orders received from terminals in a queue of orders database 125. The order matching system 124 attempts to match pairs of orders held in the queue of orders database 125 where one order in each pair is a bid to buy a particular contract and the other is an offer to sell the same contract at the same price.

A pair of orders that relate to the same contract, with one an order to buy the contract at a given price and the other an order to sell the contract at the same price will be matched by the matching system 124. An order that cannot yet be matched with any other order remains in the queue of orders 125. Orders can be partially matched if the quantities of two otherwise matching orders differ, i.e. the order for the smaller quantity will be completely matched, whilst the order for the larger quantity will be partially matched, with the order for the larger quantity modified at the electronic trading exchange system 122 so that the un-matched quantity remains at the same position in the queue of orders.

The matching system 124 may match orders on a first in first out (FIFO) basis, such that orders that were received earlier (and are hence closer to the front of the queue of orders) may be given priority over orders that were received later.

Alternatively when matching orders the matching system 124 may not give priority to orders that were received earlier, but instead may match orders on a pro rata basis. For example if two orders O₁ and O₂ to buy a contract at a price of 10 are in the queue of orders at the order matching system 124, where the quantities of orders O₁ and O₂ are 30 and 70, respectively, then if an order O₃ to sell the same contract at a price of 10 and a quantity of 10 arrives at the electronic trading exchange system 122 the order matching system 124 will partially match orders O₁ and O₂ according to their respective proportion of the total quantity (i.e. 100) bid for the contract at the price of 10, and the quantity of O₃. In this example the matched quantities of O₁ and O₂ will be 3 and 7, respectively.

Electronic trading exchange terminals 100, 128 may request that the price and/or quantity of an order that has not yet been matched (i.e. that is still in the queue of orders 125 at the electronic trading exchange system 122) be modified by transmitting to the electronic trading exchange system 122 an order modification data message. The order modification message transmitted to the electronic trading exchange system 122 comprises the unique identifier of the order to be modified, the price value to use for the modified order, and the quantity value to use for the modified order. If the electronic trading exchange system 122 receives an order modification message before the specified order is matched it will modify the specified order and transmit an order modification confirmation data message to the terminal that transmitted the order modification message. Some electronic exchanges will move the specified order to the back of the queue of orders if the order is modified, depending on the modification made, for example if the quantity of the order is increased or if the price of the order is changed the order may be moved to the back of the queue of orders.

Electronic trading exchange terminals 100, 128 may also request that an order that has not yet been matched be cancelled by transmitting to the electronic trading exchange system 122 an order cancellation data message containing the unique identifier of the order to be cancelled. If the electronic trading exchange system 122 receives an order cancellation message before the specified order is matched, the order will be cancelled and removed from the queue of orders, and the electronic trading exchange will transmit an order cancellation confirmation data message to the terminal that transmitted the order cancellation message.

Electronic trading exchange systems 122 may charge the users of terminals 100, 128 for the communications bandwidth the terminals 100, 128 consume in communicating with the systems 122. These charges may be made, for example, on the basis of the number of messages transmitted to the electronic trading exchange systems 122.

Once a pair of orders has been matched, the orders will be removed from the queue of orders (or for partially matched orders the quantity of the larger order will be reduced by the matched quantity and the order will remain in the same queue position) and for each order a fill confirmation data message will be sent to the terminal that sent the order informing it that the order has been ‘filled’ (i.e. a match has occurred for the order). This fill confirmation message contains the identifier of the order, the quantity of the order that was matched and the price it was matched at. Some electronic trading exchange systems 122 will also broadcast a trading update data message indicating that a trade (i.e. a matched pair of orders) for a contract has occurred to a plurality of terminals connected to the exchange, these being all relevant terminals, which may be all active terminals or a subset of the active terminals which are interested in the trading update data for that particular contract. The data broadcast includes the identifier of the contract that was traded, the price it was traded at, and the quantity traded.

Some electronic trading exchange systems 122 will transmit to electronic trading exchange terminals 100, 128 recent trade data messages relating to the most recently completed trade or trades for a particular contract. For example, the electronic trading exchange system 122 may transmit recent trade messages including data providing the price (or prices) and quantity (or quantities) of the most recently completed trade (or trades) for a particular contract to a terminal in such a response. Additionally some electronic trading exchange systems 122 will transmit to electronic trading exchange terminals 100, 128 current market data messages relating to the queue of bids and offers for a particular contract that have not yet been matched. For example, the electronic trading exchange system 122 may transmit current market messages including data providing the highest current bid price (i.e. the highest price of the bid orders for the contract in the queue of orders) or the lowest current offer price (i.e. the lowest price of the offer orders for the contract in the queue of orders). Some electronic trading exchange systems 122 will include in the current market messages data relating to all of the bids and offers relating to a particular contract in the queue of orders, whilst others may only include the highest bid and lowest offer in the current market messages, or the highest n bids and the lowest n offers. Both recent trade messages and current market messages relating to a particular contract may be transmitted to a terminal 100, 128 by an electronic trading exchange system 122 in response to a request made by the terminal for the recent trade data or current market data, respectively, or this data may be transmitted at regular intervals to all relevant terminals, which may be all active terminals or a subset of the active terminals which are interested in the recent trade data or current market data for that particular contract or it may be transmitted to all relevant terminals in response to a trade completing for that contract or a change in the queue of orders for that contract.

The AST terminal 100 comprises an exchange interface 106 that provides a set of standardised methods for creating, modifying and cancelling orders at a number of electronic exchanges (e.g. 122) and requesting and receiving recent trade data and current market data from those electronic exchanges by transmitting and receiving data to/from them via the communications network 126 as summarised above. The exchange interface 106 is accessible to the spreader component 108 and hedger component 110 in order to execute orders relating to spread trades as required by the user of the AST terminal 100 at either a single electronic trading exchange system 122, or at multiple electronic exchanges. The AST terminal 100 may comprise a plurality of different exchange interfaces, each adapted for different electronic trading exchange systems. Each of these exchange interfaces may be used by the spreader component 108 and hedger component 110.

The AST terminal 100 as described above is designed in such a way as to allow a user to set up the terminal to automatically perform spread trades at an electronic trading exchange system 122 (or at a number of such electronic exchanges), and to provide a number of features that allow a user to obtain a user to execute a spread trade at a price consistent with a desired price or better, and to allow the user to gain a processing advantage over other terminals 128.

A spread trade comprises at least one order to buy or sell a contract and at least one other order to buy or sell a contract where each buy/sell order is for a different contract and where the trader performing the spread trade believes that the prices of the contracts involved in the spread trade may be somehow related. Each contract that is bought or sold as part of a spread trade is known as one of the ‘legs’ of the spread trade. A trader will typically perform a spread trade when the difference between the prices of the contracts involved in the spread trade is at a pre-determined level in the hope that the difference between the prices of the same contracts will later change favourably, at which point the trader can make a profit by buying back (and selling out, as appropriate) quantities of the same contracts involved in the spread trade. A trader may also perform individual buy or sell trades which are not part of a spread trade.

For example, a trader may choose to perform a spread trade by selling a contract for crude oil at its current price of $1 per barrel and buying a contract for gasoline at its current price of $2 per barrel, as he feels that the price of the gasoline contract is currently cheap in relation to the price of the crude oil contract. If at a later stage the difference between the prices of the gasoline and crude oil contracts increases, for example if the price of the gasoline contract rises to $2.10, whilst the price of crude oil remains at its price of $1 per barrel, the trader can make a profit by buying back the crude oil contract at $1 and selling the gasoline contract at $2.10.

In order to allow a user to set up a terminal to automatically perform spread trades at an electronic trading exchange system 122 and take advantage of fluctuations in the prices of contracts, the AST terminal 100 contains a spreader component 108 and hedger component 110 that use the exchange interface 106, or a plurality of such interfaces for different exchanges, to manage spread trades entered by the user using means for accepting user input 114 to control the graphical user interface component 112. Information relating to the orders and spread trades managed by the spreader component 108 and hedger component 110 is stored in spread trade progress data 109 held in RAM 104, and may be either shared between the spreader component 108 and hedger component 110 or transferred between them when appropriate.

As is explained in greater detail below and in FIGS. 1b, 2 and 3, the user enters parameters for a new spread trade comprised of a number of ‘legs’, some of which are marked as ‘working’ legs, where each leg has a corresponding contract which is bought or sold at the electronic trading exchange system 122 in order to execute the spread trade. When the spread trade is activated by the user, the spreader component 108 creates orders at the electronic trading exchange system 122 for the working legs in order to buy or sell the contracts associated with those legs and manages these so that they will be filled at a price consistent with a desired spread price. These orders created by the spreader 108 form an initial set of working orders for the spread trade. Once an order for a working leg is filled, the hedger component 110 may execute orders at the electronic trading exchange system 122 for all the legs of the spread trade except the working leg whose order has been filled, in order to buy or sell the contracts associated with those legs at a price consistent with a desired spread price or better, and in order to complete the spread. These orders worked by the hedger 110 form a completing set of orders for the spread trade.

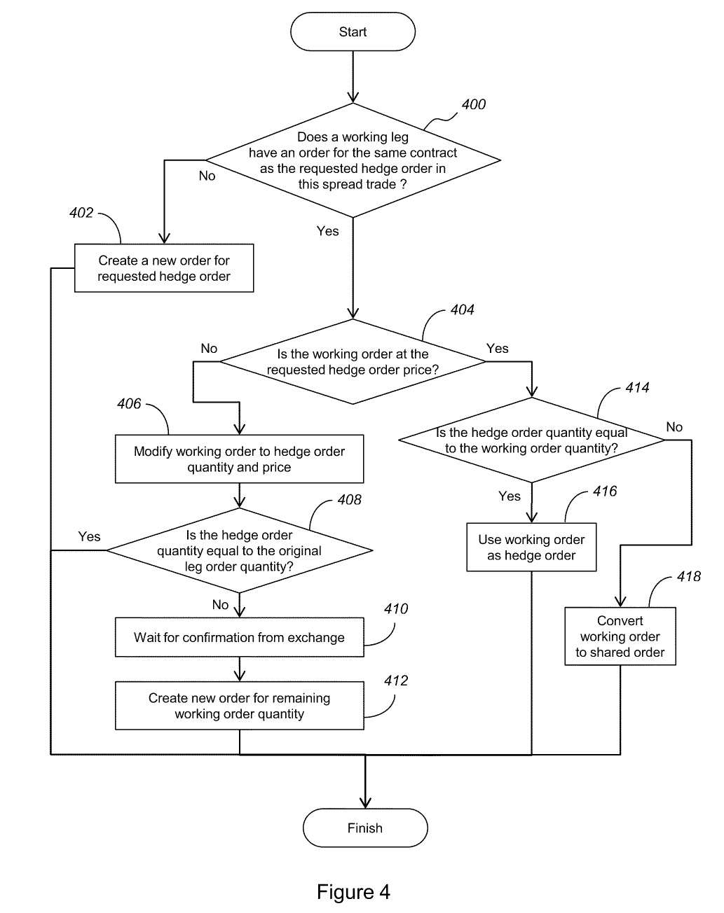

In addition as explained below and in FIGS. 4 to 11 the AST terminal 100 comprises features referred to herein as ‘Payup Hedging’, ‘Tiered Hedging’, and ‘2^{nd} Level Hedging’, ‘Queue Saving’, ‘Internal Fills’, ‘Suspend/Activate’, ‘Speculate’, ‘Lean’, ‘Manual Order’ and ‘At Best Spread Order’ that allow a user to execute a spread trade at a price consistent with a desired price (or better), and allow the user to gain a processing advantage over other automated trading systems (such as those running on the plurality of other electronic trading exchange terminals 128).

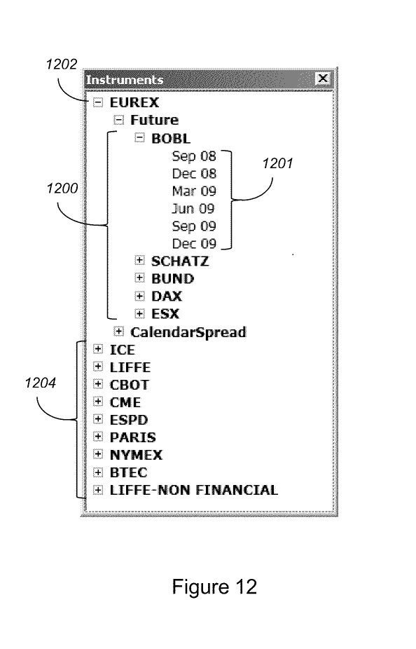

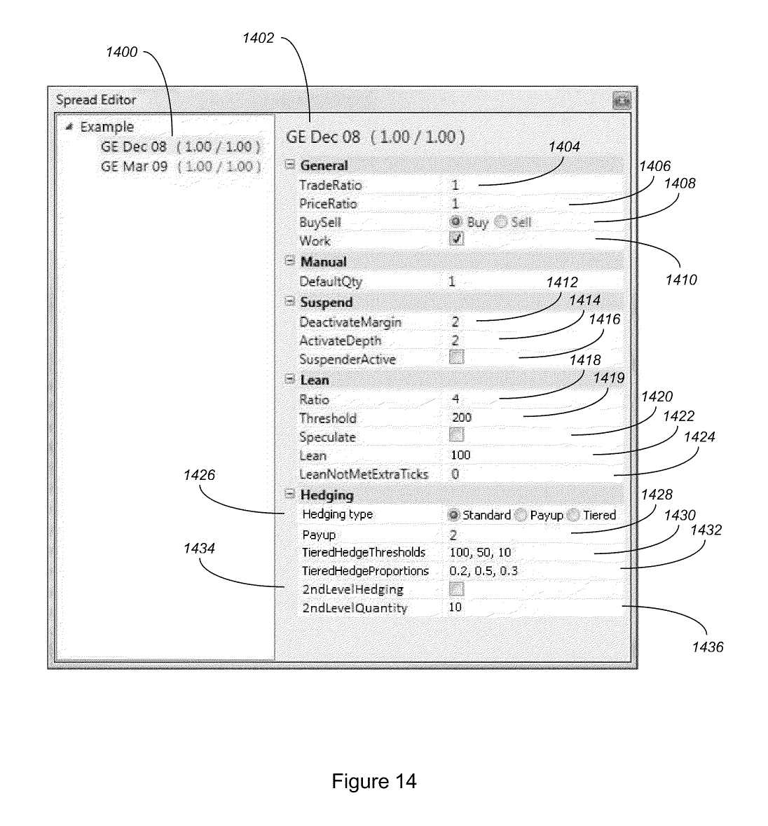

A graphical user interface is displayed to the user on the video display 118 via the graphical user interface component 112 at the AST terminal 100. FIG. 1b illustrates the steps performed to set up a spread trade and then instruct the AST terminal 100 to transmit order messages relating to the spread trade to the electronic trading exchange system 122 using this graphical user interface, and FIGS. 12 to 20 (described below) show exemplary screens of this graphical user interface. Note that the video display device(s) 118 may show a plurality of such screens simultaneously.

As illustrated in FIG. 1b, the graphical user interface component 112 first allows the user to choose whether to use an existing spread template when creating a new spread trade, or to create a new spread template (step 130). If the user wishes to create a new spread template, a list of contracts 1200 with various expiry dates 1201 available at various electronic exchanges 1202, 1204 is displayed in a screen and the user may select the contracts of the appropriate expiry dates of which the new spread template will be comprised, as shown in FIG. 12 (step 132). Each contract selected will form one of the ‘legs’ of spread trades created using the new spread template, and these selected contracts form the spread trade set of contracts, with information relating to said spread trade set of contracts being stored in the spread template.

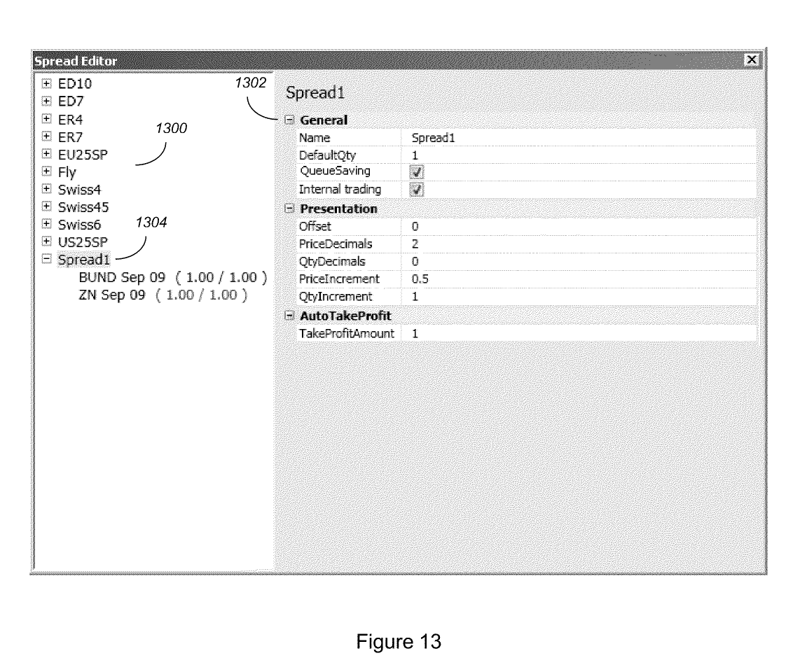

Once a spread template has been selected, for example by selecting an existing spread template 1304 from the list of spread templates 1300 in FIG. 13 (step 134), or a new spread template that has been created according to step 132, the user can set several parameters 1302 relating to the spread template such as the name of the spread template and parameters defining the display of prices for spread trades created from the spread template.

The user may edit spread trade parameters 1402 relating to each individual leg of the spread template by first selecting the leg 1400 and then editing the spread trade parameters 1402 for that leg. Amongst these spread trade parameters are the trade ratio 1404 and price ratio of the leg 1406, whether the leg may be bought or sold 1408, and whether or not the leg is marked as a working leg 1410. These spread trade parameters are adjusted by the user in steps 136 to 140 and their meanings are summarised below. In addition to parameters 1404 to 1410, the user is able to set a number of further parameters 1412 to 1436 relating to optional features of the AST terminal 100 that are described along with the features to which they correspond in detail below.

The pricing ratio of each leg of a spread trade is set by the user so as to equalise the correlation between the prices of the legs of the spread trade during spread price calculations, for example if the user is creating a spread template for two contracts A and B, and it is known to the user that when the price of contract A increases in value by 1 tick the price of contract B generally increases by 2 ticks, the user would set the pricing ratios pₐ and p_{b} of A and B, respectively, to pₐ=2 and p_{b}=1.

The trading ratio of each leg of a spread is set by the user so as to determine the quantity of each contract that is ordered when a spread is executed, allowing the user to try and equalise the change of value of each leg in the spread trade. For example if the user is creating a spread template for two contracts C and D, and it is known to the user that the value of one C contract is twice as much as the value of one D contract, the user would set the trading ratios t_{c} and t_{d} of C and D to t_{c}=1 and t_{d}=2, respectively (assuming equal price ratios p_{c} and p_{d} for contracts C and D).

The legs of a spread trade that have been marked as working legs in the spread template are the legs that first have orders at the electronic trading exchange system 122 created for them by the spreader component 108. By marking some of the legs of a spread template as working legs the user is able to define which contracts will have orders executed for them that form an initial set of working orders for each spread trade that is created from the spread trade template. The spreader component 108 manages these orders in this initial set of working orders so that they will be filled at a price consistent with the spread order price (or better), recent trade data and current market data known to the spreader 108. Once the spreader component 108 receives a fill confirmation message for an order in the initial set of working orders for a spread trade, the spreader 108 will instruct the hedger 110 to execute orders for the other contracts of the spread trade besides the contract to which the filled order relates. These orders or ‘hedge orders’ executed by the hedger 110 form a completing set of orders that are managed by the hedger 110 so that they will also be filled at a price consistent with the spread order price (or better), recent trade data and current market data known to the hedger 110.

In alternative embodiments of the invention the user may not mark any of the legs of a spread template as working legs in order to create a spread template for a ‘No Working Legs’ order. When a spread trade based on this spread template is executed the spreader 108 may not create an initial set of working orders, and instead orders forming a completing set of orders for all the legs of the spread trade are executed by the hedger 110, as described in further detail for the ‘No Working Legs’ order below.

In alternative embodiments of the invention the spreader 108 may not create working orders forming an initial set of working orders for the spread trade if it detects that the calculated buy/sell prices that would be used for these working orders would be immediately satisfied under current market conditions. In this case in step 204 the spreader 108 immediately instructs the hedger 110 to execute a hedge order for every leg of the spread trade in order to create a ‘Monitor Only’ order, as described in further detail below.

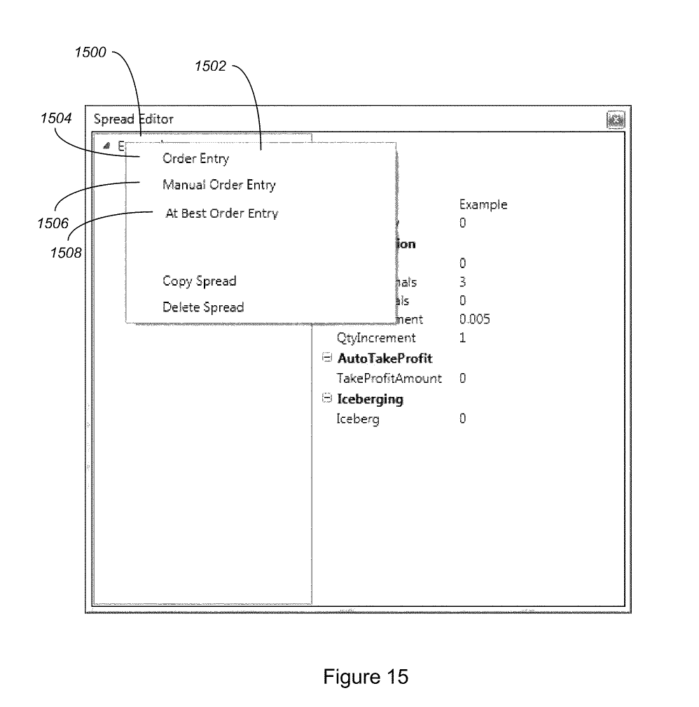

The user can then open a new on-screen interface referred to herein as a ‘ticket’ for a spread template from which new spread trades can be activated based on the settings chosen in steps 130 to 140 (step 142). FIG. 15 shows an exemplary screenshot of how the user creates a new ticket from a selected spread template 1500 by opening a ‘menu’ 1502 listing new ticket types (e.g. by clicking on that spread template in the screen shown in FIG. 15 with the right button of a mouse connected to the means for accepting user input 114) and selecting the required new ticket type 1504, 1506, 1508. Tickets are provided for a standard spread trade 1504 as well as for what will be referred to below as a ‘Manual Order’ ticket 1506 and an ‘At Best Order’ ticket 1508, each of which takes advantage of additional features of the system as described below.

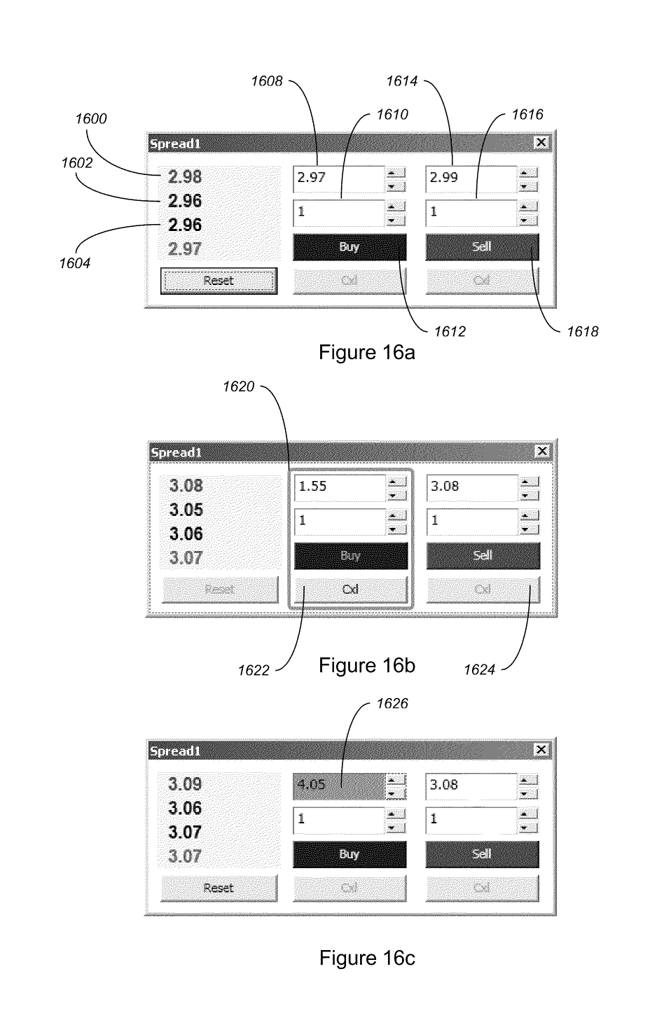

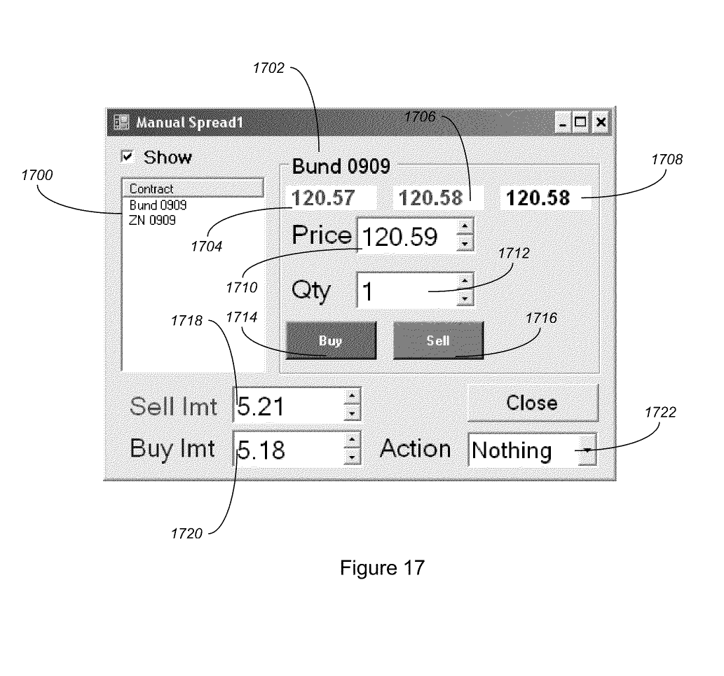

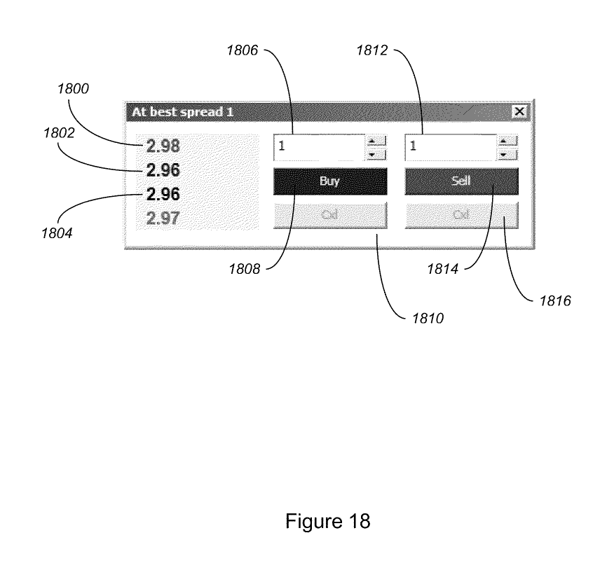

Each ticket created by the user is shown in a new window. FIG. 16a shows an exemplary screenshot of a ticket window for a standard spread trade, and FIGS. 17 and 18 show exemplary screenshots of an ‘Manual Order’ ticket and an ‘At Best Order’ ticket, respectively. Market values for the spread trade are displayed in the ticket window for a standard spread trade, indicating the lowest offer price 1600 on the market for the spread trade, the highest bid price 1602 and the price at which the spread trade was traded most recently 1604. The graphical user interface component 112 regularly uses the exchange interface 106 to request and receive recent trade data and current market data from the electronic trading exchange system 122 relating to the contracts of the legs of the spread template to which a ticket corresponds, and then updates the market values shown on the ticket window (i.e. 1600 to 1604) using this data, as summarised below.

The most recent offer price and most recent bid price for a spread trade involving legs A, B, C and D, where the spread template settings determine that legs A and C may be bought, and legs B and D may be sold are given by:

Spread offer price=(pₐ*Oₐ)−(p_{b}*B_{b})+(p_{c}*O_{c})−(p_{d}*B_{d})

Spread bid price=(pₐ*Bₐ)−(p_{b}*O_{b})+(p_{c}*B_{c})−(p_{d}*O_{d})

where pₐ . . . p_{d} are the pricing ratios of legs A to D taken from the spread template of the spread trade, Bₐ . . . B_{d} are the current highest bid prices for legs A to D, and Oₐ . . . O_{d} are the current lowest offer prices for legs A to D, respectively, where Bₐ . . . B_{d} and Oₐ . . . O_{d} are obtained from current market data. Similarly the price at which the spread trade was traded at most recently is given by:

Last traded spread price=(pₐ*Tₐ)−(p_{b}*T_{b})+(p_{c}*T_{c})−(p_{d}*T_{d})

where Tₐ . . . T_{d} are the last prices at which legs A to D were traded at most recently.

The user can then set the ‘spread order price’ which is the price at which to buy/sell a new spread trade (in the entry fields 1608 or 1614 as appropriate) created from the selected spread template, and can set a ‘quantity multiplier’ (in the entry fields 1610 or 1616 as appropriate) to determine how much of the spread trade to buy/sell (step 144).

If a spread trade of type buy could be immediately filled at the spread order price entered in field 1608 (i.e. as the entered spread order price is larger than the lowest offer price) or if a spread trade of type sell could be immediately filled at the spread order price entered in field 1614 (i.e. as the entered spread order price is smaller than the highest bid price) then the graphical user interface component 112 may indicate this in the appropriate spread order price field 1608 or 1614 by highlighting that field, as shown for the ‘buy’ spread order price 1626 in FIG. 16c.

In the ticket window for a standard spread trade illustrated in FIG. 16a the user is provided with a ‘buy’ spread trade button 1612 and a ‘sell’ spread trade button 1618. By clicking on one of these buttons the user will activate a new spread trade based on the spread template and the settings chosen (i.e. in steps 130 to 140) (step 146). If the user activates a new spread trade by pressing on the ‘buy’ spread trade button 1612, the buy/sell type of the new spread trade is set to buy so that the spreader component 108 is instructed to try to buy the spread (at the electronic trading exchange system 122) at a price consistent with the spread order price (or better) entered in 1608. Similarly if the user activates a new spread trade by pressing on the ‘sell’ spread trade button 1612, the buy/sell type of the new spread trade is set to sell so that the spreader component 108 is instructed to sell the spread (at the electronic trading exchange system 122) at a price consistent with the spread order price (or better) entered in 1614.

Thus the user can use a ticket for a standard spread trade to buy a spread at a first price 1608, and sell the same spread at a second price 1614, higher than the first price, in order to make a profit. When the user activates a new spread trade in step 146, the spreader component 108 takes the information entered by the user in steps 130 to 144 above, stores this information relating to a new spread trade as spread trade progress data 109 in RAM 104 and begins the process of submitting an initial set of working orders in order to execute the new spread trade.

The graphical user interface component 112 disables either the buy or sell button that the user has pressed on the ticket, enables a cancel button 1622 or 1624 corresponding to the buy/sell spread trade entered, and highlights that a buy or sell spread trade has been entered on a particular ticket by, for example, highlighting the buy/sell portion of the ticket with a box 1620 as shown in FIG. 16b, where a buy order has been activated on the ticket.

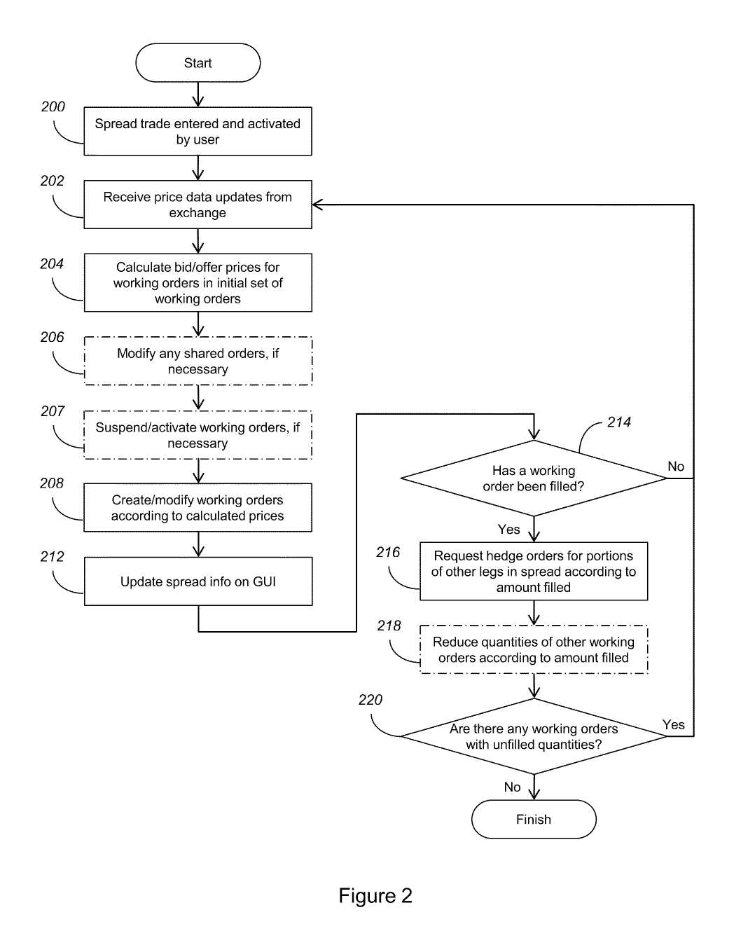

FIG. 2 illustrates the steps performed by the spreader component 108 in order to execute an initial set of working orders for a new spread trade after a new spread trade has been activated (e.g. by the user in step 146). The spreader component 108 first gathers the required information relating to the new spread trade and stores it in spread trade progress data 109 for the spread trade in RAM 104 (step 200). Information relating to the new spread trade is gathered from a spread template along with the additional settings entered by the user into a ticket for the new spread trade.

The spreader component 108 requires the following information in order to execute a new spread trade: a link to the spread template that determines the contracts that form the spread trade set of contracts of the new spread trade as well as settings relating to the spread trade and its legs, the buy/sell type of the new spread trade, its spread order price, and its quantity multiplier. This information is stored in spread trade progress data 109 for the spread trade in RAM 104. As the spread trade is managed by the spreader 108 and hedger 110, information relating to the progress of the spread trade is also stored in spread trade progress data 109 for the spread trade, such as the quantity required of each contract relating to the spread trade, information relating to the orders for the spread trade (which have been transmitted in the form of order messages to the electronic trading exchange system 122), information relating to the progress of these orders, such as the quantity filled on each order and the price being used for each order, and finally recent trade data and current market data received by the either the spreader 108 or the hedger 110 that relates to the contracts of the spread trade.

The spreader component 108 then selects the appropriate buy/sell type for each leg of the new spread trade according to the buy/sell type of each leg set by the user in the spread template settings and the buy/sell type of the new spread trade, and stores the buy/sell types in spread trade progress data 109 for the spread trade. If the buy/sell type of the new spread trade is set to buy each leg of the spread will be bought or sold according to the buy/sell type parameter of each leg, as set by the user in the spread template. If the buy/sell type of the new spread trade is set to sell each leg of the spread will be bought or sold using the opposite of the buy/sell type set in the for each leg in the spread template.

The spreader component 108 also calculates the quantities to use for the orders for each leg as follows, and stores this information in spread trade progress data 109 for the spread trade. For each leg X the quantity Q * tₓ of the contract of the leg will be bought/sold, where Q is the ‘quantity multiplier’ of the spread that may be bought/sold (e.g. as set by the user in entry fields 1610 or 1616), and tₓ is the trade ratio of the leg X (stored in the spread template).

The spreader component 108 then uses the exchange interface 106 to request and receive recent trade data and current market data relating to the contracts of the spread trade set of contracts of the new spread trade from the electronic trading exchange system 122, and stores this information in spread trade progress data 109 for the spread trade (step 202).

The spreader component 108 then calculates the price to use for orders in the initial set of working orders of the new spread trade in order to buy/sell the spread trade at a price consistent with the spread order price (or better), and stores this information in spread trade progress data 109 for the spread trade (step 204). The spreader component 108 uses the recent trade data and current market data received for the contracts of the spread trade set of contracts, the pricing ratios of the legs (stored in the spread template) and the spread order price to calculate the prices to use for the orders in the initial set of working orders for the spread trade. Examples follow showing the calculations used to determine the prices of the orders for working legs A and B of a spread trade involving legs A, B, C and D, where the spread template settings for the legs of the spread trade determine that the contracts for legs A and C may be bought, for legs B and D may be sold, and the legs for contracts A and B are working legs.

If the buy/sell type of the spread trade is of type buy then the buy/sell types of the legs of the spread trade are the same as defined in the spread template settings, and so the price Wₐ at which working leg A may be bought is calculated so that:

(pₐ*Wₐ)−(p_{b}*B_{b})+(p_{c}*O_{c})−(p_{d}* B_{d})≦S

is satisfied, where pₐ . . . p_{d} are the pricing ratios of legs A to D, B_{b} and B_{d} are the current highest bid prices for legs B and D respectively, obtained from current market data, O_{c} is the current lowest offer price for leg C, and S is the spread order price. Note that order prices transmitted to the electronic trading exchange system 122 may typically be integer numbers of ticks, hence Wₐ may be rounded down to the nearest tick by the spreader component 108 in order to satisfy the equation above. Similarly if the spread entered is of type buy then the price W_{b} at which working leg B may be sold is calculated so that:

(pₐ*Oₐ)−(p_{b}*W_{b})+(p_{c}*O_{c})−(p_{d}*B_{d})≦S

is satisfied, where Oₐ is the current lowest offer price for leg A. W_{b} may be rounded up to the nearest tick by the spreader component 108.

If the buy/sell type of the spread trade is of type sell then the buy/sell types of the legs of the spread trade are the opposite to what is defined in the spread template settings, i.e. legs A and C may be sold, and legs B and D may be bought. The price Wₐ at which working leg A may be sold is calculated so that:

(pₐ*Wₐ)−(p_{b}*O_{b})+(p_{c}*B_{c})−(p_{d}*O_{d})≧S

is satisfied, where O_{b} and O_{d} are the current highest bid prices for legs B and D respectively, obtained from current market data and B, is the current lowest offer price for leg C. Wₐ may be rounded up to the nearest tick by the spreader component 108. Similarly if the spread entered is of type sell then the price W_{b} at which working leg B may be bought is calculated so that:

(pₐ*Bₐ)−(p_{b}*W_{b})+(p_{c}*B_{c})−(p_{d}*O_{d})≧S

is satisfied, where B, is the current highest bid price for leg A. W_{b} may be rounded down to the nearest tick by the spreader component 108.

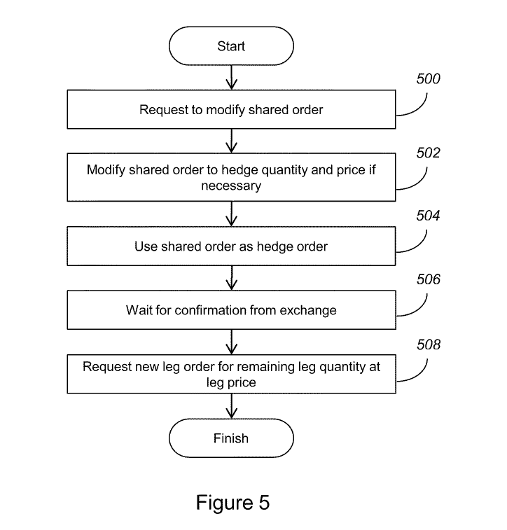

Once the prices for the orders in the initial set of working orders of the spread have been calculated in step 204, the spreader component 108 may optionally perform step 206 if the ‘Queue Saving’ feature of the AST terminal 100 is enabled, in order to modify the price of any ‘shared orders’ linked to the working legs of the spread trade. The actions performed by the spreader 108 in step 206 are illustrated in FIG. 5 and described in detail below along with the other steps performed by the AST terminal 100 in order to provide the functionality for the ‘Queue Saving’ feature.

The spreader component 108 then uses the exchange interface 106 to create a new order for each working leg at the appropriate electronic trading exchange system 122 using the determined buy and sell prices. In this way the initial set of working orders is created for the spread trade, and information relating to this initial set of working orders is stored in spread trade progress data 109 for the spread trade. If an order has already been created for a working leg in a previous iteration of steps 202 to 216, the spreader component 108 uses the exchange interface 106 to modify the existing order for each working leg to its newly calculated price (step 208).

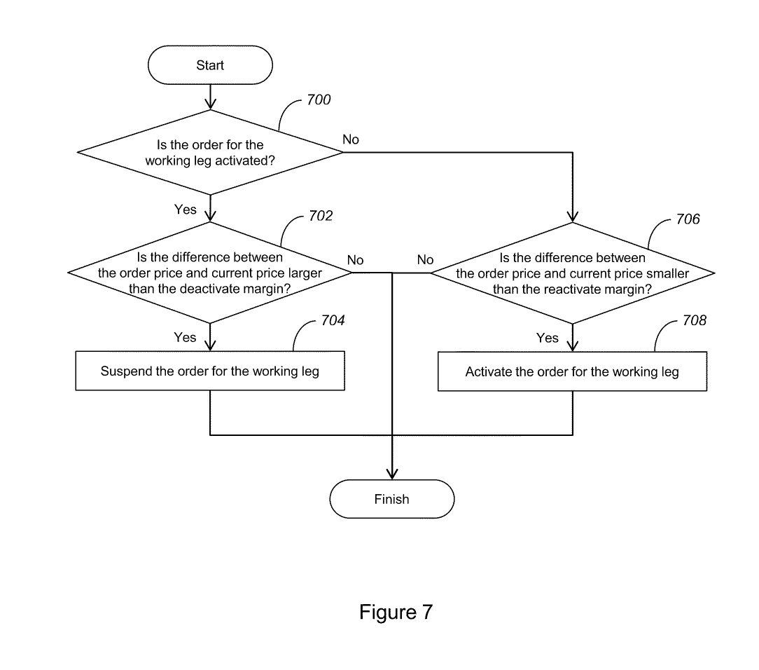

The spreader 108 can then optionally perform step 207 if the ‘Suspend/Activate’ feature of the AST terminal 100 is enabled in order to suspend or re-activate orders for any of the working orders in the initial set of working orders according to the current market data and recent trade data. A working order in the initial set of working orders can be suspended when the price at which the order is to be bought/sold is ‘far away’ from the bid/offer prices known from current market data, and a suspended order can be re-activated at a later stage when the price at which the order is to be bought/sold re-approaches the bid/offer prices known from current market data, as is illustrated in FIG. 7 and described in detail below.

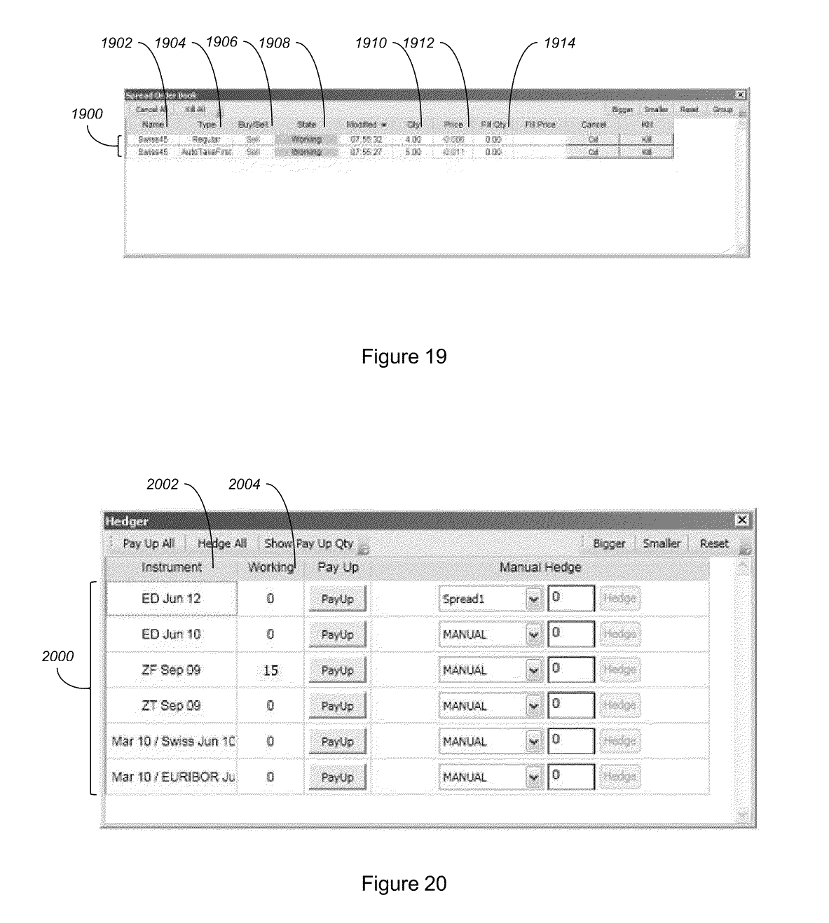

The spreader 108 will then instruct the graphical user interface component 112 to update information relating to the spread trade listed in a spread order list window, as exemplified by the screen shown in FIG. 19, where a list of spread trades 1900 is shown (step 212). Each entry in this list of spread trades 1900 corresponds to a spread trade that is being managed by the spreader 108 and hedger 110 and shows the name 1902 of the spread template on which this spread trade is based, the type of the ticket 1904 from which the spread trade was created, the buy/sell type 1906 of the spread trade, the quantity multiplier 1910 of the spread trade, the current price of the spread trade in relation to the spread order price 1912, and the quantity filled on the spread trade 1914. When the graphical user interface is instructed to update this list of spread trades 1900 it gathers the above information from the spreader 108, hedger 110 and exchange interface 106 in order to do so.

The spreader component 108 then checks whether the exchange interface 106 has received a fill confirmation message indicating that an order for a working leg of the spread trade (i.e. one of the orders in the initial set of working orders) has been ‘filled’, and if so and records this and the quantity filled (as specified in the filled confirmation message) in spread trade progress data 109 for the spread trade (step 214). An order in the initial set of working orders will be filled if another electronic trading exchange terminal 128 connected to the electronic trading exchange system 122 has entered an order that matches the order for the working leg, i.e. at a price consistent with the spread order price (or better), the recent trade data and the current market data known to the AST terminal 100.

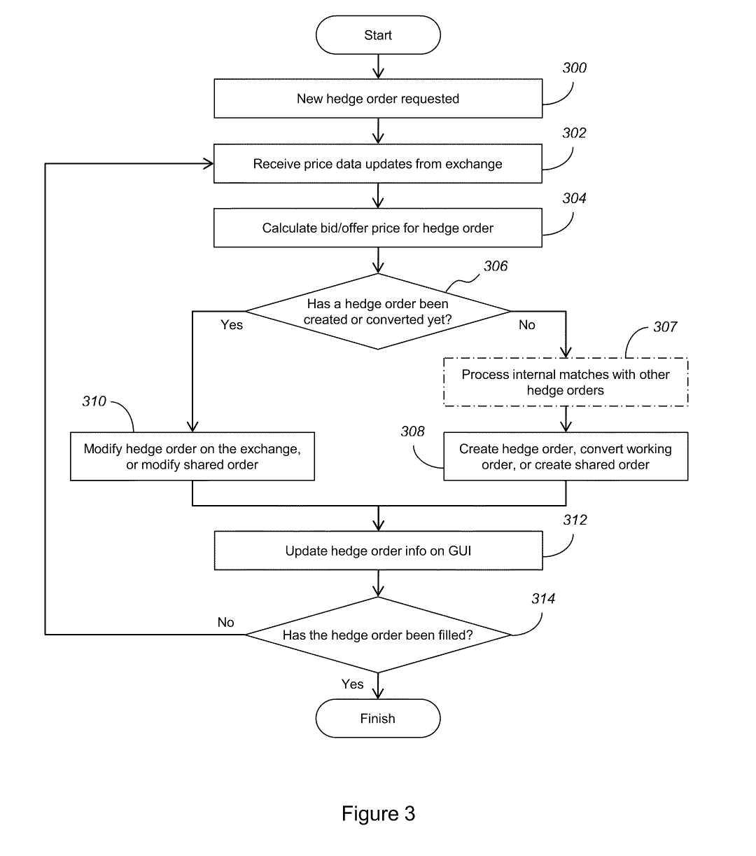

Hence when an order in the initial set of working orders of a spread trade is filled the spread trade could be completed to satisfy the desired spread order price by immediately having orders filled for the other legs of the spread trade. Orders for the remaining legs of the spread trade may be transmitted to the electronic trading exchange system 122 immediately to take advantage of the current market for the other legs of the spread trade. This is accomplished by the spreader component 108 instructing the hedger component 110 to execute a completing set of orders at the electronic trading exchange system 122 consisting of an order message for each of the legs of the spread trade except the working order that has been filled (step 216). The spreader 108 will inform the hedger 110 of the spread trade progress data 109 to access in relation to the spread trade for which completing set of orders are to be created so that the spread trade progress data 109 for the spread trade is shared between the spreader 108 and hedger 110, or alternatively spread trade progress data 109 is passed from the spreader 108 to the hedger 110 and not shared by the two components. The spreader component 108 also informs the hedger component 110 of the identifiers of the contracts for the legs for which orders may be submitted, and, as is described below, the spreader component 108 informs the hedger component 110 of the quantity to order for each order that will form the completing set of orders. The hedger component 110 then calculates the prices of each order in the completing set of orders (each of which is referred to herein as a ‘hedge’ order), stores this information in spread trade progress data 109 for the spread trade, and then manages the orders in the completing set of orders as illustrated in the steps shown in FIG. 3 and described below.

In step 216 the fill confirmation message received by the exchange interface 106 for the filled working leg will indicate the quantity of the order that was matched. The hedger component 110 may thus be instructed to transmit order messages for the completing set of orders of the spread trade with quantities ordered according to the matched quantity of the filled working leg. The spreader component 108 calculates the quantity qₓ for the order message for an order X in the completing set of orders that is to be transmitted to the electronic trading exchange system 122 by the hedger component 110 according to:

qₓ=Fₐ/tₐ*tₓ

the result of which the spreader 108 may round up or down to the nearest integer, where Fₐ is the filled quantity of the filled working leg A, tₐ and tₓ are the trading ratios of the legs A and X, respectively, and stores this information in spread trade progress data 109 for the spread trade. Note that if the filled working leg has been completely filled then Fₐ=tₐ*Q in which case qₓ=Q*tₓ, where Q is the ‘quantity multiplier’ of the spread trade.

If the ‘Queue Saving’ feature of the AST terminal 100 is not enabled, then after the hedger component 110 has been requested to execute hedge orders for the completing set of orders, the quantities of any orders in the initial set of working orders for this spread trade managed by the spreader component 108 except the working order that has been filled may be reduced by an amount corresponding to the filled quantity of the order for the filled working leg (step 218). The spreader component 108 calculates the reduced quantity q′ₓ that may be used for the working order X in the initial set of working orders according to:

q′ₓ=qₓ−Fₐ/tₐ*tₓ

the result of which the spreader 108 may round up or down to the nearest integer, and where qₓ is the current quantity remaining on order X, and stores this information in spread trade progress data 109 for the spread trade. The spreader component 108 uses the exchange interface 106 to transmit order modification messages to the electronic trading exchange system 122 to modify the quantities of each of the orders for the initial set of working orders besides the working order that has been filled, where the modified quantities are calculated as above. If the working order that has been filled has been completely matched, then in step 218 the spreader component 108 may delete the orders for the other working orders in the initial set of working orders of the spread trade besides the one that has been filled (as the spread trade may now be entirely managed by the hedger component 110 which is managing the completing set of orders), and records this in spread trade progress data 109 for the spread trade.

If the working order that has been filled was not completely filled, that order (and orders for the other orders in the initial set of working orders if more than one working leg was marked by the user) will remain at the electronic trading exchange system 122 with an unfilled quantity, so the spreader component 108 returns to step 202 to continue receiving price updates and adjusting the prices of the orders in the initial set of working orders in order to try to achieve the required spread order price for the unfilled quantity (step 220).

Otherwise if the test in step 220 is not satisfied the spreader component 108 can finish managing this spread trade and allow the hedger component 110 to complete it. Additionally if the spread trade was created using a ticket for a standard spread trade the spreader component 108 instructs the graphical user interface 112 to re-enable the appropriate buy/sell button (1612 or 1618) on the ticket, disable the appropriate cancel button (1622 or 1624), and to remove the highlighting around the appropriate portion (e.g. 1620) of the ticket for the spread trade as shown in FIG. 16c. If the spread trade was created using a ‘Manual Order’ ticket or an ‘At Best Spread Order’ ticket then changes made to the graphical user interface are described below.

FIG. 3 illustrates the steps performed by the hedger component 110 in order to fill a hedge order for a leg of a spread trade where that hedge order belongs to the completing set of orders of the spread trade, after one of the working orders in the initial set of working orders of the spread trade has been filled at a price consistent with the spread order price (or better), recent trade data and current market data known to the spreader 108. Firstly, the hedger component 110 receives instructions from the spreader component 108 indicating that a new order message may be required for a hedge order that forms one of the completing set of orders of the spread trade (note that the spreader component 108 will request a new hedge order for each leg of the spread trade besides the one which has just been filled, in order to form the completing set of orders) (step 300). The hedger component 110 will receive from the spreader component 108 the identifier of the contract for which a hedge order is to be placed, spread trade progress data 109 for the spread trade to which the hedge order relates, and the quantity that may be ordered.

The hedger component 110 then uses the exchange interface 106 to request and receive recent trade data and current market data relating to the contract of the requested hedge order from the electronic trading exchange system 122 (step 302). Alternatively the hedger component 110 could use the most recently received recent trade data and current market data obtained by the spreader component 108 (in step 202) relating to the contract for the requested hedge order.

The hedger component 110 then uses the recent trade data and current market data received for the contract of the requested hedge order to calculate the price at which this order may be bought or sold, depending on the buy/sell instructions from the spreader component 108 (step 304). The hedger 110 will use one of several different methods to calculate the price at which to buy/sell this contract for this requested hedge order, depending on a ‘Hedging Type’ setting 1426 set by the user in the spread template for the leg for this hedge order. The methods available are referred to herein as ‘ Standard Hedging’, ‘Payup Hedging’, ‘Tiered Hedging’ and ‘2^{nd} Level Hedging’ and are each explained in detail below.

If the user has set the ‘Hedging Type’ setting 1426 to ‘Standard Hedging’ for the leg for which a hedge order has been requested then the hedger 110 calculates the price for the hedge order for this leg as follows. If the spread trade progress data 109 for the spread trade indicates that the hedger component 110 should enter a buy order for the leg, the hedger component 110 uses the lowest offer price known from current market data as the buy price for that order. If the spread trade progress data 109 for the spread trade indicates that the hedger component 110 should enter a sell order for the leg, the hedger component 110 uses the highest bid price known from current market data as the sell price for that order.

Alternatively if the user has set the ‘Hedging Type’ setting 1426 to ‘Payup Hedging’ for the leg for which a hedge order has been requested then the hedger component 110 may try and buy/sell the contract for the requested hedge order at a better price than is currently bid/offered on the market in order to obtain a better fill price for the user. When calculating the price for the order for this leg, if the buy/sell type of the leg is of type buy, the hedger component 110 uses the price 1 tick less than the lowest offer price known from current market data as the buy price for the order, unless current market data indicates that the quantity offered at the lowest offer price is less than a ‘PayUp’ threshold set by the user in the spread template in field 1428, in which case the lowest offer price is used. Similarly if the buy/sell type of this leg is of type sell, the hedger component 110 uses the price 1 tick more than the highest bid price known from current market data as the sell price for the order for this leg, unless current market data indicates that the quantity bid at the highest bid price is less than the ‘PayUp’ threshold 1428 in which case the highest bid price is used.

Alternatively if the user has set the ‘Hedging Type’ setting 1426 to ‘Tiered Hedging’ for the leg for which a hedge order has been requested then the hedger component 110 may try and buy/sell the contract for the requested hedge order at a better price than is currently offered on the market in order to obtain a better fill price for the user. With ‘Tiered Hedging’ selected in the spread template for a leg, the user may set a plurality of decreasing ‘Tiered Hedging’ thresholds 1430 and corresponding plurality of ‘Tiered Hedging’ proportions 1432 in the spread trade template for the leg. The ‘Tiered Hedging’ thresholds represent examples of user-defined relationships on the quantities available at the electronic trading exchange system 122 at the highest bid/lowest offer which are known for the contract for the leg from current market data. If the quantity available at the best buy/sell price for the contract of a leg known from current market data does not satisfy a user-defined relationship on the quantity available at the best buy/sell price for the contract of a leg, such as for example where the quantity available at the best buy/sell price for the contract of a leg known from current market data is less than a ‘Tiered Hedging’ threshold, then the price of a proportion of the originally requested quantity of the hedge order determined by the ‘Tiered Hedging’ proportion corresponding to that ‘Tiered Hedging’ threshold may be adjusted so that that proportion of the hedge order is bought/sold at the current lowest offer/highest bid price for that contract, as explained in further detail below. Thus ‘Tiered Hedging’ may be used to reduce the quantity of a contract on order at a given price level from a first non-zero quantity to a second non-zero quantity. The sum of the ‘Tiered Hedging’ proportions may be equal to one so that all of the original quantity of the spread trade is represented by the ‘Tiered Hedging’ proportions.

If ‘Tiered Hedging’ is activated for a leg and the buy/sell type of the leg is of type buy, the hedger component 110 uses the price one tick less than the lowest offer price known from current market data as the buy price for the hedge order for the leg as long as a user defined relationship on the quantity offered at the lowest offer price for that leg's contract is satisfied, such as for example where the quantity offered at the lowest offer price for that leg's contract is greater than the first (i.e. largest) ‘Tiered Hedging’ threshold 1430. If the quantity offered at the lowest offer price does not satisfy a user-defined relationship, such as for example where the quantity offered at the lowest offer price is less than a ‘Tiered Hedging’ threshold 1430, the lowest offer price is used for a proportion of the quantity of the hedge order equal to the ‘Tiered Hedging’ proportion 1432 that corresponds to that ‘Tiered Hedging’ threshold. Thus the quantity of a contract on order at a given price level (i.e. one tick less than the lowest offer price) may be reduced from a first non-zero quantity to a second non-zero quantity by using the lowest offer price as the price for a proportion of the quantity of the hedge order.

For example if the user defined relationship on the quantity offered at the lowest offer price for a leg's contract involves two ‘Tiered Hedging’ thresholds 1430 for a leg of buy/sell type buy that are set at 100 and 50 with corresponding ‘Tiered Hedging’ proportions are set at 0.4 and 0.6, respectively, then if the current market data indicates that the quantity offered at the lowest offer price for that leg's contract is greater than 100 then the hedger component 110 uses the price 1 tick less than the lowest offer price known from current market data as the buy price for the hedge order for the leg. If current market data indicates that the quantity offered at the lowest offer price for that leg's contract is less than 100 then the hedger component 110 uses the lowest offer price as the price for 40% of the originally requested quantity of the hedge order. Additionally if current market data indicates that the quantity offered at the lowest offer price for that leg's contract is less than 50 then the hedger component 110 also uses the lowest offer price as the price for 60% of the originally requested quantity of the hedge order.

If the quantity offered at the lowest offer price does not satisfy a user-defined relationship, such as for example where the quantity offered at the lowest offer price is less than a ‘Tiered Hedging’ threshold 1430 and the price of a corresponding proportion of the quantity of the hedge order is adjusted to the lowest offer price as above, the hedger 110 may use the exchange interface 106 to transmit an order data message to the electronic trading exchange system 122 in order to create a second hedge order for the same contract with the same buy/sell type as the current hedge order, but with the price of this second hedge order adjusted to the lowest offer price, and the quantity of this second hedge order set to the quantity of the current hedge order multiplied by the appropriate ‘Tiered Hedging’ proportion 1432. The hedger 110 may also use the exchange interface 106 to transmit an order modification message to the electronic trading exchange system 122 in order to reduce the quantity of the current hedge order to its original quantity subtracted by the quantity of second hedge order.

The ‘Tiered Hedging’ feature of the AST terminal 100 works similarly if the buy/sell type of the leg is type sell, as described below. The hedger component 110 uses the price one tick greater than the highest bid price known from current market data as the sell price for the hedge order for this leg as long as a user defined relationship on the quantity bid at the highest bid price for that leg's contract is satisfied, such as for example where the quantity bid at the highest bid price for that leg's contract is greater than the first (i.e. largest) ‘Tiered Hedging’ threshold 1430. If the quantity offered at the highest bid price does not satisfy a user-defined relationship, such as for example where the quantity offered at the highest bid price is less than a ‘Tiered Hedging’ threshold 1430 the highest bid price is used for a proportion of the quantity of the hedge order equal to the ‘Tiered Hedging’ threshold. Thus the quantity of a contract on order at a given price level (i.e. one tick greater than the highest bid price) may be reduced from a first non-zero quantity to a second non-zero quantity by using the highest bid price as the price for a proportion of the quantity of the hedge order.

For example if the user defined relationship on the quantity offered at the highest bid price for a leg's contract involves two ‘Tiered Hedging’ thresholds 1430 for a leg of buy/sell type sell that are set at 100 and 50 with corresponding ‘Tiered Hedging’ proportions are set at 0.4 and 0.6, respectively, then if the current market data indicates that the quantity bid at the highest bid price for that leg's contract is greater than 100 then the hedger component 110 uses the price 1 tick greater than the highest bid price known from current market data as the sell price for the hedge order for the leg. If current market data indicates that the quantity bid at the highest bid price for that leg's contract is less than 100 then the hedger component 110 uses the highest bid price as the price for 40% of the originally requested quantity of the hedge order. Additionally if current market data indicates that the quantity bid at the highest bid price for that leg's contract is less than 50 then the hedger component 110 also uses the highest bid price as the price for 60% of the originally requested quantity of the hedge order.

If the quantity offered at the highest bid price does not satisfy a user-defined relationship, such as for example where the quantity offered at the highest bid price is less than one of the ‘Tiered Hedging’ thresholds 1430 and the price of a corresponding proportion of the quantity of the hedge order is adjusted to the highest bid price as above, the hedger 110 may use the exchange interface 106 to transmit an order data message to the electronic trading exchange system 122 in order to create a second hedge order for the same contract with the same buy/sell type as the current hedge order, but with the price of this second hedge order adjusted to the highest bid price, and the quantity of this second hedge order set to the quantity of the current hedge order multiplied by the appropriate ‘Tiered Hedging’ proportion 1432. Again, the hedger 110 may also use the exchange interface 106 to transmit an order modification message to the electronic trading exchange system 122 in order to reduce the quantity of the current hedge order to its original quantity subtracted by the quantity of the second hedge order.

Alternatively, rather than modifying a single order when it is necessary to buy/sell a portion of a hedge order at a different price (i.e. when a user-defined relationship on the quantity available at the best buy/sell price for the contract of a leg is not satisfied) when using ‘Tiered Hedging’, the hedger 110 may transmit one order for each ‘Tiered Hedging’ threshold 1430 entered by the user for the leg to which the requested hedge order belongs when the hedger 110 performs step 308 (described below). The quantity of each of these created orders is set to be equal to the requested quantity of the requested hedge order multiplied by one of the ‘Tiered Hedging’ proportions 1432, so for example if the ‘Tiered Hedging’ proportions are set to 0.4 and 0.6 and a quantity of 100 is requested for the hedge order, two orders will be created for the hedge order with quantities set to 40 and 60, respectively. Thus if the quantity offered at the lowest offer price for the contract of a hedge order of buy/sell type buy does not satisfy a user-defined relationship such as where for example the quantity offered at the lowest offer price for the contract is less than a ‘Tiered Hedging’ threshold 1430, the hedger 110 adjusts the price of the corresponding order that was created for that ‘Tiered Hedging’ threshold to the lowest offer price as above. Similarly if the quantity bid at the highest bid price for the contract of a hedge order of buy/sell type sell does not satisfy a user-defined relationship such as where for example the quantity bid at the highest bid price for the contract is less than a ‘Tiered Hedging’ threshold 1430, the hedger 110 adjusts the price of the corresponding order that was created for that ‘Tiered Hedging’ threshold to the highest bid price as above.

In alternative embodiments of the invention the hedger component 110 could try and buy/sell the contract for a leg for which a hedge order has been requested at a better price than is currently offered on the market if the ‘2^{nd} Level Hedging’ feature of the AST terminal 100 is enabled in combination with either the ‘Payup Hedging’ feature or the ‘Tiered Hedging’ feature described above. The ‘2^{nd} Level Hedging’ feature is enabled using the setting 1434 in the spread template for the leg. When both ‘2^{nd} Level Hedging’ and either ‘Payup Hedging’ or ‘Tiered Hedging’ are activated, the hedger component 110 will perform the steps described above for either ‘Standard Hedging’ or ‘Tiered Hedging’ (depending on which of the two is enabled). However if the buy/sell type of this leg is of type buy and current market data indicates that the quantity offered at the price one tick greater than the lowest offer price is less than a ‘2^{nd} Level Hedging’ quantity set by the user in field 1436 of the spread template for settings the leg, the hedger 110 uses the lowest offer price known from current market data as the buy price for the hedge order for this leg. Similarly if the buy/sell type of this leg is of type sell and current market data indicates that the quantity bid at the price one tick less than the highest bid price is less than the ‘2^{nd} Level Hedging’ quantity 1436, the hedger 110 uses the highest bid price known from current market data as the offer price for the hedge order for this leg.

In alternative embodiments of the invention the hedger 110 may choose to try to buy or sell a hedge order at either the best price available or one tick better than the best price available (i.e. one tick less if the order is of buy/sell type buy, and one tick greater if the order is of buy/sell type sell) by comparing the most recently received current market data (or a sequence of most recently received current market data) with a historical database of current market data that may have been recorded by the AST terminal 100 or for example recorded by an electronic market monitoring system, and then setting the price at which to buy or sell the hedge order as above depending on the result of this comparison.

Once the buy/sell price for the requested hedge order has been calculated in step 304 according to one of the methods described above, the hedger component 110 stores the calculated buy/sell price for the requested hedge order in spread trade progress data 109 for the spread trade and will then check whether an order has been created for the requested hedge order yet (step 306) and if not will do so by proceeding to step 307.

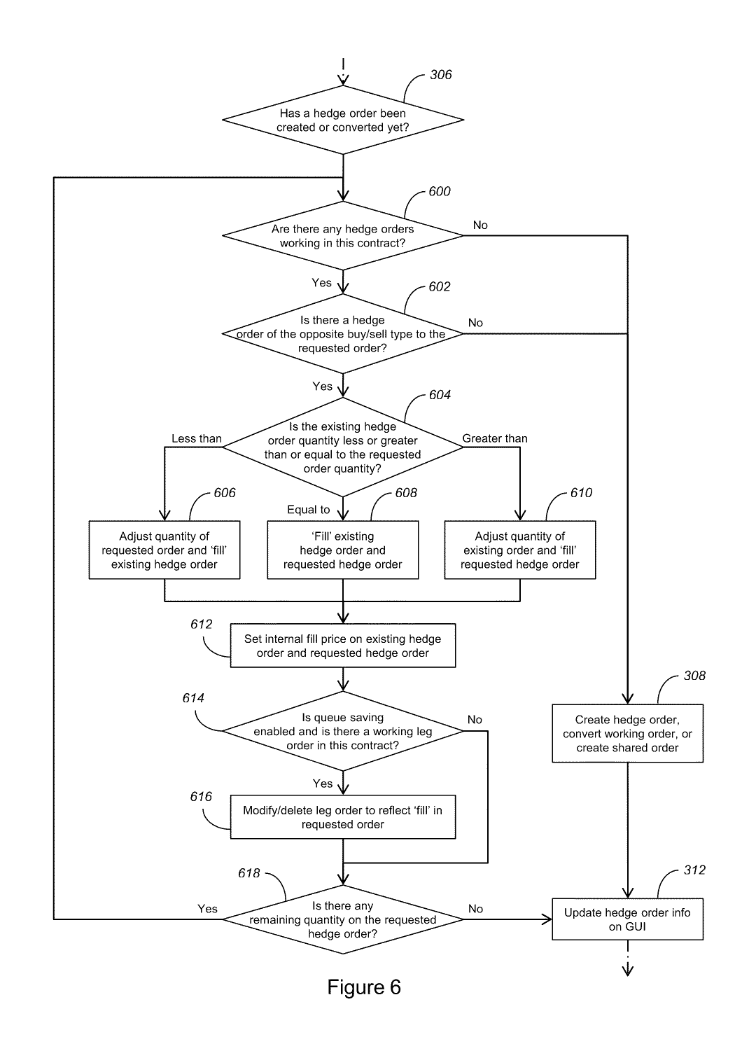

The hedger 110 will perform step 307 if the ‘Internal Trading’ feature is enabled for the spread trade using the appropriate setting 1302 in the spread trade template for the spread trade. In step 307 the hedger 110 will attempt to match the requested hedge order with existing opposing hedge orders and fill these internally, without creating a new order for the requested hedge order at the electronic trading exchange system 122 (or converting an existing hedge order if ‘Queue Saving’ is activated as described below). In order to do this the hedger performs the steps illustrated in FIG. 6 described below before proceeding to step 308. If the ‘Internal Trading’ feature of the hedger 110 is not enabled the hedger 110 will proceed immediately to step 308.

In step 308 the hedger component 110 uses the exchange interface 106 to create a new order at the appropriate electronic trading exchange system 122 for the hedge order that has been requested, where the order is for the contract of the requested hedge order, is of the determined buy/sell type and the requested quantity, and is given the buy/sell price determined by the hedger 110 in step 304.

Alternatively if the ‘Queue Saving’ feature is enabled for the spread trade using the appropriate setting 1302 in the spread trade template then if in step 308 the leg for which a hedge order is requested has a corresponding working order the hedger 110 may use that order as the new hedge order, or may attempt to ‘share’ that order with the spreader 108 in order to create a ‘shared order’. In this case the actions performed by the hedger 110 in step 308 are illustrated in FIG. 4 and described in detail below along with the other steps performed by the AST terminal 100 in order to provide the functionality for the ‘Queue Saving’ feature.

If a hedge order has already been created for the leg in a previous iteration of steps 302 to 314, the hedger component 110 uses the exchange interface 106 to modify the existing hedge order for the leg to its newly calculated price from step 304 by transmitting an order modification message specifying the new price to the electronic trading exchange system 122 (step 310).

Alternatively if the ‘Queue Saving’ feature is enabled and this leg is linked to a shared order then in step 310 the hedger 110 will modify the ‘shared order’ if appropriate. In this case the actions performed by the hedger 110 in step 310 are illustrated in FIG. 5 and described in detail below along with the other steps performed by the AST terminal 100 in order to provide the functionality for the ‘Queue Saving’ feature.

The hedger 110 will then instruct the graphical user interface component 112 to update information relating to the hedge order listed in the hedge orders list, as exemplified by the screen shown in FIG. 20, where a list of potential hedge orders 2000 is shown (step 312). Each entry in this list of potential hedge orders 2000 relates to potential hedge orders managed by the hedger 110 and shows the name of the contract 2002 to which the hedge orders relate, the total quantity of these hedge orders 2004 that are being managed by the hedger 110.

The hedger component 110 then checks whether the exchange interface 106 has received a fill confirmation message indicating that the hedge order for the leg has been filled, i.e. matched at the electronic trading exchange system 122, and if so records this and the amount filled (as specified by the fill confirmation message) in spread trade progress data 109 for the spread trade (step 314). If the hedge order has not been filled then the hedger component 110 may try to buy/sell the leg at a better price than is currently offered on the market as described above using ‘Payup Hedging’, ‘Tiered Hedging’, or ‘2^{nd} Level Hedging’, by returning to step 302 in order to receive recent trade data and current market data updates from the electronic trading exchange and modify the hedge order price according to these. If in step 314 the hedger 110 has received a fill confirmation message indicating that the hedge order for the leg has been filled, the hedger 110 instructs the graphical user interface 112 to update the hedge orders list shown in FIG. 20 with information relating to the fill of the hedge order.

In alternative embodiments of the invention the hedger 110 may not return to step 302 if a hedge order has not been filled and may instead wait at step 314 until the hedge order is filled, without modifying the price of the hedge order according to any of the ‘Payup Hedging’, ‘Tiered Hedging’, or ‘2^{nd} Level Hedging’ methods described above.

Once the hedger component 110 has completely filled all of the hedge orders of a spread trade (i.e. all the orders in the completing set of orders for the spread trade requested by the spreader 108) the spread trade is complete. The hedger 110 instructs the graphical user interface component 112 to update the spread trades list shown in FIG. 19 with information relating to the completion of the spread trade.

The use of an AST terminal 100 to execute a spread trade as described above can benefit a user as the AST terminal 100 can react immediately upon receiving recent trade data or current market data from the electronic trading exchange system 122 indicating that market conditions have become suitable to perform a spread trade, whereas a user executing the individual orders of a spread trade manually may miss the suitable market conditions or may not react to them appropriately. Additionally the AST terminal 100 provides a number of features that allow a user to obtain a user to execute a spread trade at a price consistent with a desired price or better, and to provide a number of features that allow the user to gain a processing advantage over other terminals 128. These features are described in detail below.

As summarised above the AST terminal 100 provides a ‘Queue Saving’ feature that a user can enable by using the settings 1302 in the spread template for a spread trade. With the ‘Queue Saving’ feature is enabled for a spread trade, when an order in the initial set of working orders of a spread trade managed by the spreader 108 is filled and the hedger 110 is requested to create hedge orders for the remaining legs corresponding to the completing set of orders of the spread trade, if the hedger 110 is requested to create a hedge order for a leg that has a working order in the initial set of working orders, the hedger 110 may use that order as the new hedge order, or may attempt to ‘share’ that order with the spreader 108 in order to create a ‘shared order’.

In this way, the queue position in the order matching system 124 of the working orders in the initial set of working orders of the spread trade that have not been filled is preserved for the hedge orders in the completing set of orders that are created for the legs of these working orders. This allows the user of the AST terminal 100 to gain an advantage over other terminals 128 that may lose their queue position at the electronic trading exchange system 122 because they first cancel unfilled orders for the unfilled working legs of a spread trade before creating new orders to hedge the same legs. By avoiding this using the ‘Queue Saving’ feature the user of the AST terminal 100 is also able to reduce the bandwidth consumed on the communications network 126. A performance advantage is also gained over other terminals that may wait for confirmation that an order for an unfilled working leg has been cancelled before creating a corresponding hedge order so as to avoid the possibility of both the order for the unfilled working leg and the corresponding hedge order being filled and causing a user to buy/sell more of a contract than desired (i.e. what is known as a ‘double fill’). The ‘Queue Saving’ feature of the AST terminal 100 ensures that the user can only ever get filled on the desired amount of the leg of a spread trade, and avoids the delay of cancelling and then creating a new order when a new hedge order is requested.

When the ‘Queue Saving’ feature of the system is enabled, the hedger 110 creates or converts orders or shared orders for hedge orders in step 308 according to the steps illustrated in FIG. 4, described below. If an existing order for a working leg is used as a shared order, that order is modified according to the steps shown in FIG. 5 if it becomes necessary for the spreader 108 to modify the price of a working leg in step 206 or the hedger 110 to modify the price of a hedge order in step 310. It is not necessary for the spreader 108 to perform step 218 when the ‘Queue Saving’ feature is enabled. If a shared order is filled, either the spreader 108 or hedger 110 may be assigned the filled portion of the shared order, as is described in detail below.

FIG. 4 illustrates an alternative set of steps performed by the hedger component 110 in order to create or convert an order or shared order for a new hedge order in step 308 of FIG. 3 when the ‘Queue Saving’ feature of the AST terminal 100 is enabled.

The hedger 110 first checks the spread template for the new hedge order so as to determine whether the leg to which the requested new hedge order belongs is marked as a working leg, and if so the hedger 110 then checks spread trade progress data 109 for the spread trade in order to determine whether that working leg has a working order in the initial set of working orders for that spread trade (step 400). If not, the hedger 110 uses the exchange interface 106 to create a new order at the appropriate electronic trading exchange system 122 for the hedge order that has been requested, where the order is for the contract of the requested hedge order, is of the determined buy/sell type and the requested quantity, is given the buy/sell price determined by the hedger 110 in step 304 (step 402), and the hedger 110 then continues to manage the new hedge order as normal according to the steps illustrated in FIG. 3, after storing this information in spread trade progress data 109 for the spread trade.

Otherwise if the tests in step 400 are satisfied, the hedger 110 will either use the order for the working leg as the order for the hedge order, or convert the order for the working leg into a shared order by performing the remaining steps illustrated in FIG. 4. The hedger 110 will first check spread trade progress data 109 for the spread trade in order to determine if the price value of the order for the working leg is the same as the price that has been determined by the hedger 110 in step 304 for the requested hedge order (step 404).

If the test in step 404 is not satisfied, the hedger 110 will use the exchange interface 106 to transmit an order modification message to the electronic trading exchange system 122 in order to change the price of the order for the working leg to the price determined for the new hedge order, and to change the quantity of the order for the working leg to the quantity requested for the new hedge order (step 406).

The hedger 110 then checks whether the quantity requested for the new hedge order is equal to the quantity that remained on the order for the working leg prior to step 406 (step 408). If this is the case, an order is no longer needed for the working leg, as another working order in the set of working orders for the spread trade must have been completely filled in order for a new hedge order of the requested quantity to have been requested. The hedger 110 can thus assume responsibility for the order for the working leg and treat it as the order for the requested hedge order, i.e. as one of the completing set of orders for the spread trade. This order is then managed by the hedger 110 as normal according to the steps in FIG. 3. The spreader 108 will be instructed by the hedger 110 to mark the order for the working leg as cancelled (in the spread trade progress data 109 for the spread trade) and so the spreader 108 may no longer manage the working leg.

If in step 408 the hedger 110 determined that the quantity requested for the new hedge order was not equal to the quantity that remained on the order for the working leg then an order is still needed for the working leg, as none of the initial set of working orders of the spread trade have been completely filled. The hedger 110 thus waits until the exchange interface 106 has received an order modification confirmation data message in response to the order modification message transmitted to the electronic trading exchange system 122 before proceeding (step 410). Once this confirmation has been received, the hedger 110 instructs the spreader 108 to use the exchange interface 106 to create a new order for the working leg of spread trade which will form one of the initial set of working orders of the spread trade and will replace the working order that has been transferred to the hedger 110 (step 412). The price of the new order for the working leg will be the price used for the previous order for the working leg before it was modified in step 408, and the quantity of the new order will be the quantity used for the previous order subtracted by the quantity requested for the new hedge order. The spreader 108 will store this information in spread trade progress data 109 for the spread trade and then manage the new order for the working leg as normal according to the steps illustrated in FIG. 2, whilst the hedger 110 will manage the converted hedge order as normal according to the steps in FIG. 3.

If in step 404 the hedger 110 determined that the price value of the order for the working leg was the same as the price that had been determined by the hedger 110 in step 304 for the requested hedge order, the hedger will first check if the quantity requested for the new hedge order is equal to the quantity of the order for the working leg (step 414). If this is the case, an order is no longer needed for the working leg, as another working order in the set of working orders for this spread trade must have been completely filled in order for a new hedge order of the requested quantity to have been requested. The hedger 110 can thus assume responsibility for the order for the working leg and treat it as the order for the requested hedge order, i.e. as one of the completing set of orders for the spread trade. This order is then managed by the hedger 110 as normal according to the steps in FIG. 3. The spreader 108 will be instructed to mark the order for the working leg as cancelled (in the spread trade progress data 109 for the spread trade) and so may no longer manage this working leg.

If in step 414 the hedger 110 determined that the quantity requested for the new hedge order was not equal to the quantity of the order for the working leg, the hedger 110 converts the order for the working leg into a ‘shared order’ by setting a shared order flag for the order in the spread trade progress data 109 for the spread trade (step 418). In this way both the working leg and the requested hedge order are linked to this shared order. The hedger 110 informs the spreader 108 of the quantity of the shared order that is required for the new hedge order and records this quantity in the spread trade progress data 109 for the spread trade, and the spreader 108 marks the remaining quantity of the shared order besides that required for the new hedge order as required for the working leg. The order is thus shared by the spreader component 108 (which uses its portion of the order as the order for the working leg) and by the hedger component 110 (which uses its portion of the order as the requested new hedge order), who both continue to manage the working order and requested hedge order as normal according to FIG. 2 and FIG. 3, except that if either component wishes to modify the price of the shared order or if a fill occurs on the shared order the procedures outlined below are followed.

FIG. 5 shows the steps that may be performed by either the spreader 108, or the hedger 110, if either of these components requests to modify the price of a shared order in step 206 or step 310, respectively.

Firstly, a request to modify the price of a shared order is either made by the spreader 108 to itself (if the spreader 108 wishes to change the price of a shared order in step 206) or is made by the hedger 110 to the spreader 108 (if the hedger 110 wishes to change the price of a shared order in step 310) (step 500).

If it is the hedger 110 that has made a request to the spreader 108 to modify the price of a shared order, the spreader 108 uses the exchange interface 106 to transmit an order modification message to the electronic trading exchange system 122 in order to change the price of the shared order to the price requested by the hedger 110 for the hedge order, and to change the quantity of the shared order to the quantity that the spreader 108 was informed was required for the hedge order in step 418 (step 502). If it is the spreader 108 that has made a request to itself to modify the shared order, the spreader 108 uses the exchange interface 106 to transmit an order modification message to the electronic trading exchange system 122 in order to change the quantity of the shared order to the quantity that the spreader 108 was informed was required for the hedge order in step 418, but the price of the shared order is kept the same as the shared order is still at the price required for the hedge order.

The shared order is now suitable for use by the hedger 110 as the hedge order, i.e. as one of the completing set of working orders for the spread trade, and the changes made to this order are recorded by the spreader 108 in spread trade progress data 109 for the spread trade (step 504). The converted hedge order is managed as normal according to FIG. 3 by the hedger 110.

The spreader 108 then waits for the exchange interface 106 to receive confirmation in the form of an order modification confirmation data message that the order modification message sent in step 502 has been processed by the electronic trading exchange system 122 (step 506). The spreader then uses the exchange interface 106 to transmit a new order to use for the working leg to the electronic trading exchange systems 122 that the shared order was linked to which will form one of the initial set of working orders of the spread trade and will replace the working order that has been transferred to the hedger 110 and stores information relating to this new order in spread trade progress data 109 for the spread trade (step 508). The new order is for the same contract and has the same buy/sell type as the shared order, but is for the quantity that was marked as required for the working leg in step 418. If it was the hedger 110 that requested that the shared order be modified in step 500, the price of the new order should be the same as that of the shared order before it was modified in step 502, otherwise if it was the spreader 108 that requested that the shared order be modified in step 500, the price of the new order is set to the price requested by the spreader 108 (i.e. which was determined in step 204).

The new order is then treated as the order for the working leg to which the shared order had been linked, and is managed as normal by the spreader 108 according to FIG. 2.

If a shared order is filled before either the spreader 108 or the hedger 110 attempts to modify the price of the shared order according to the steps shown in FIG. 5, the filled quantity on the shared order may be prioritised by the spreader 108 to either the hedge order or to the working leg linked to the shared order. For example, a fill on a shared order may be prioritised by the spreader 108 so that the filled quantity is assigned to the hedge order linked to the shared order first, and, if the hedge order is completely filled, the remaining filled quantity on the shared order is assigned to the working leg linked to the shared order. Alternatively a fill on a shared order may be prioritised by the spreader 108 so that the filled quantity is assigned to the working leg linked to the shared order first, and, if the working leg is completely filled, the remaining filled quantity on the shared order is assigned to the hedge order linked to with the shared order. Alternatively the filled quantity on the shared order could be split evenly by the spreader 108 between the working leg and the hedge order, or split between the two by the spreader 108 on a pro-rata basis.

When a fill on a shared order occurs, the filled quantities on both the hedge order and the working leg are managed as normal by the hedger 110 in step 314 and spreader 108 in step 214, respectively. If the hedge order linked to the shared order is completely filled by a fill on the shared order, the shared order is converted back into an order for the working leg by the spreader 108 and the remaining quantity on that order is then managed as normal by the spreader 108 according to the steps in FIG. 2. If the working leg linked to the shared order is completely filled by a fill on the shared order, the shared order is converted into an order for the hedge order by the spreader 108 and the remaining quantity on that order is then managed as normal by the hedger 110 according to the steps in FIG. 3. If both the hedge order and the working leg are completely filled by a fill on the shared order both the hedger 110 and spreader 108 manage these fills as normal according to steps 314 and 214 respectively and both finish managing the shared order.

The AST terminal 100 provides an ‘Internal Fills’ feature that allows the hedger 110 to match pairs of opposing hedge orders (i.e. a pair of hedge orders with opposite buy/sell types) for the same contract (where each of this pair of hedge orders belongs to the completing set of orders of a different spread trade) without submitting both orders to the electronic trading exchange system 122. This allows the user of the AST terminal 100 to avoid costs imposed by the electronic trading exchange system 122 associated with trading contracts, and to gain a processing advantage by avoiding the need to transmit and wait for the completion of a hedge order, if that order can be matched by the hedger 110. FIG. 6 illustrates steps performed by the hedger component 110 in step 307 of FIG. 3 in order to process ‘Internal Fills’ when a new hedge order is requested, when this feature has been enabled for the spread trade to which the requested hedge order belongs using the appropriate setting 1302 in the spread trade template for the spread trade. As shown in FIG. 3, after the hedger component 110 receives instructions from the spreader component 108 requesting a new hedge order forming one of the completing set of orders of a spread trade in step 300, receives price data updates from the exchange in step 302, and calculates the bid or offer price for the requested hedge order, the hedger 110 will perform step 307 if the ‘Internal Fills’ feature is enabled after determining in step 306 that an order has not yet been created for the requested hedge order.

The hedger 110 first checks spread trade progress data 109 for other spread trades to determine whether it is already managing any hedge orders (e.g. from other spread trades managed by the AST terminal 100, or hedge orders manually entered by the user using the AST terminal 100) with the same contract as the requested hedge order (step 600). If not, the hedger 110 proceeds to step 308 and continues managing the new hedge order request as normal according to the steps shown in FIG. 3, but otherwise the hedger 110 will check if there is an existing hedge order for the same contract as the requested hedge order that is also of the opposite buy/sell type to the requested hedge order (step 602). If there is not, the hedger 110 proceeds to step 308 and continues managing the new hedge order request as normal according to the steps shown in FIG. 3, but otherwise the hedger 110 will compare the quantity of the existing hedge order with that of the requested hedger order in step 604 as described below. If there is more than one existing hedge order with the same contract as the requested hedge order and that is of the opposite buy/sell type to the requested order, a selection criteria may be used in step 602 to select which one of these existing hedge orders will be compared in step 604. The selection criteria could for example choose the existing hedge order that was created first.

In step 604 the hedger will compare the quantity of the existing hedge order found in step 602 with that of the requested hedge order and proceed to step 606, 608 or 610 depending on whether the quantity of the existing hedge order is less than, equal to, or greater than that of the requested hedge order, respectively.

If the quantity of the existing hedge order found in step 602 is less than that of the requested hedge order, the hedger 110 can ‘match’ the two so that the existing hedge order is completely filled internally (i.e. without transmitting an order for the requested hedge order to the electronic trading exchange system 122), and the requested hedge order is partially filled internally (step 606). The hedger 110 uses the exchange interface 106 to transmit an order cancellation message to the electronic trading exchange system 122 in order to cancel the existing hedge order. The hedger 110 may then wait for the exchange interface 106 to receive an order cancellation confirmation data message that confirms the cancelation of the existing hedge order at the electronic exchange trading system 122. The hedger 110 then marks the existing hedge order as completely filled in spread trade progress data 109 for the spread trade to which the existing hedge order belongs so that when the hedger 110 next checks whether the existing order is filled in step 314 the internal fill is noted and management of the existing hedge order is completed as normal according to the steps in FIG. 3. The hedger 110 also reduces the unfilled quantity of the requested hedge order by the quantity of the existing hedge order, and marks that a quantity equal to the quantity of the existing hedge order has been filled on the requested hedge order and stores this information in spread trade progress data 109 for the spread trade to which the requested hedge order belongs.

If the quantity of the existing hedge order found in step 602 is equal to that of the requested hedge order, the hedger 110 can ‘match’ the two so that both the existing hedge order and the requested hedge order are completely filled internally (step 608). The hedger 110 uses the exchange interface 106 to transmit an order cancellation message to the electronic trading exchange system 122 in order to cancel the existing hedge order. The hedger 110 may then wait for the exchange interface 106 to receive an order cancellation confirmation data message that confirms the cancelation of the existing hedge order at the electronic exchange trading system 122. The hedger 110 then marks the existing hedge order as completely filled in spread trade progress data 109 for the spread trade to which the existing hedge order belongs so that when the hedger 110 next checks whether the existing order is filled in step 314 the internal fill is noted and management of the existing hedge order is completed as normal according to the steps in FIG. 3. The hedger 110 also reduces the quantity of the requested hedge order to zero, marks that a quantity equal to the quantity of the existing hedge order has been filled on the requested hedge order and stores this information in spread trade progress data 109 for the spread trade to which the requested hedge order belongs.

If the quantity of the existing hedge order found in step 602 is greater than that of the requested hedge order, the hedger 110 can ‘match’ the two so that the existing hedge order is partially filled internally, and the requested hedge order is completely filled internally (step 610). The hedger 110 uses the exchange interface 106 to transmit an order modification message to the electronic trading exchange system 122 in order to reduce the quantity of the existing hedge order by the quantity of the requested hedge order. The hedger 110 may then wait for the exchange interface 106 to receive an order modification confirmation data message that confirms the modification of the existing hedge order at the electronic exchange trading system 122. The hedger 110 then marks the existing hedge order as partially filled in spread trade progress data 109 for the spread trade to which the existing hedge order belongs, where the quantity filled is the same as the quantity of the requested hedge order, so that when the hedger 110 next checks whether the existing order is filled in step 314 the internal fill is noted and management of the existing hedge order is continued as normal according to the steps in FIG. 3. The hedger 110 also reduces the unfilled quantity of the requested hedge order to zero, marks that a quantity equal to the quantity of the requested hedge order has been filled on the requested hedge order and stores this information in spread trade progress data 109 for the spread trade to which the requested hedge order belongs.

After the internal fills have been marked and the filled quantities calculated in either step 606, 608 or 610, the hedger 110 calculates the price at which the existing hedge order found in step 604 and the requested hedge order may be matched by the hedger 110 and sets this as the matched price on the internally matched quantities of both orders in the relevant spread trade progress data 109 for these orders (step 612). If the current prices of the two orders are equal, the hedger 110 can match the two orders at their current price. If the current prices of the two orders are not equal however, the hedger 110 may match the two orders at the current price of the requested hedge order. Alternatively if the current prices of the two orders are not equal the hedger 110 may match the two orders at the current price of the existing hedge order, or at the average of the two prices.

The hedger 110 then checks whether the ‘Queue Saving’ feature is enabled, and if so checks whether the requested new hedge order belongs to a leg that is marked as a working leg, and if so the hedger 110 then checks whether there is an order for that working leg (step 614).

If the test in step 614 is satisfied then as ‘Queue Saving’ is enabled the order for the working leg found in step 614 will later be converted in step 308 into to the new order for the requested hedge order through the steps illustrated in FIG. 4. To ensure that, given the internal fill that has occurred in step 606, 608 or 610, the correct quantity is used for the order for the existing order for the working leg and for the new order for the requested hedge order after the ‘Queue Saving’ steps in FIG. 4 have been performed during step 308, the hedger 110 may instruct the spreader 108 to use the exchange interface 106 to transmit an order modification message to the electronic trading exchange system 122 in order to reduce the quantity of the order for the working leg by the amount filled on the requested hedge order in either of steps 606, 608 or 610 (step 616). If the spreader 108 is instructed to reduce the quantity of the existing order for the working leg by an amount that would reduce the order quantity to zero, the spreader 108 instead uses the exchange interface 106 to transmit an order cancellation message to the electronic trading exchange system 122 to cancel the order for the working leg.

After step 616 or if the test in step 614 was not satisfied, the hedger 110 tests whether there remains any unfilled quantity on the requested hedge order (step 618). If there remains any unfilled quantity on the requested hedge order, the hedger returns to step 600 in order to try to internally match the remainder of the requested hedge order with other hedge orders for the same contract. If no matching contracts are then found in steps 600 and 602 the hedger 110 proceeds to step 308 and continues managing the request for the remaining unfilled quantity of the requested new hedge order as normal according to the steps shown in FIG. 3.

If in step 618 the hedger 110 finds that the requested hedge order has been completely filled internally (i.e. it has no unfilled quantity remaining), then the hedger 110 need not create a new hedge order for the requested hedge order and can proceed to step 312 in order to update the hedge order information displayed using the graphical user interface 112 before it finishes to manage the requested hedge order in step 314.

In alternative embodiments of the invention the hedger 110 may also match hedge orders managed by the hedger 110 with working orders managed by the spreader 108 by considering these working orders when trying to internally match a request for a new hedge order during steps 600 and 602 of the ‘Internal Fills’ feature.

In alternative embodiments of the invention the spreader 108 may attempt in step 208 to match a request for a new working order with an existing hedge order managed by the hedger 110 internally, where the request for a new working order and the existing hedge order relate to the same contract and have the opposite buy/sell type, rather than transmitting an order data message to the electronic trading exchange system 122 to create a new order for the requested working order.

The ‘Suspend/Activate’ feature allows the spreader 108 to avoid transmitting order modification messages for orders for working legs (i.e. orders that are in the initial set of working orders for a spread trade) if a threshold criterion is not satisfied such as for example if they are unlikely to be filled at current market prices, thus avoiding the unnecessary transmission of order modification messages to the electronic trading exchange system 122 when it is necessary to change the prices of these orders, and hence reducing the bandwidth consumed by the AST terminal 100 on the communications network 126. As some electronic trading exchange systems 122 impose fines on users who transmit excessive numbers of messages to the electronic trading exchange systems 122 this feature may also help reduce the likelihood of the user of the AST terminal 100 incurring such a fine. Before an order for a working leg is first transmitted to the electronic exchange trading system 122 transmission of the order may be delayed until a first threshold criterion is satisfied, such as for example if the price at which the order for a working leg is to be bought/sold is ‘far away’ from the bid/offer prices known from current market data, transmission of the order may be delayed until the price at which the order is to be bought/sold re-approaches the bid/offer prices known from current market data. Once an order for a working leg has been transmitted to the electronic exchange trading system 122 that working leg can be suspended if a second threshold criterion is satisfied, such as for example when the price at which the order is to be bought/sold is ‘far away’ from the bid/offer prices known from current market data, and the suspended working leg can be re-activated at a later stage if the first threshold criterion is satisfied, such as for example when the price at which the order is to be bought/sold re-approaches the bid/offer prices known from current market data.

FIG. 7 illustrates steps performed by the spreader component 108 for a working leg so as to suspend or re-activate that working leg according to a second threshold criterion or first threshold criterion, respectively, such as according to the current market data and recent trade data known to the spreader 108 from step 202. The steps in FIG. 7 are performed for each working leg in a spread trade (i.e. each of which may have an order in the initial set of working orders of that spread trade) during step 207, if the ‘Suspend/Activate’ feature of the spreader 108 is activated for the leg by the setting 1416 in the spread template settings for the leg. The spreader 108 first checks whether the working leg is currently marked as activated or not (i.e. suspended) (step 700). Note that if no order has been created for the working leg yet, the working leg is considered to be marked as suspended. If the working leg is marked as activated, the spreader 108 will then check whether the second threshold criterion is satisfied, such as for example whether the absolute difference between the price to be used for the order for the working leg (as calculated in step 204) and the current highest bid or lowest offer price (depending on whether the order is a bid or offer, respectively) known from current market data of the contract for that order is larger than the sum of a ‘Deactivate Margin’ value set by the user in field 1412 and an ‘Activate Depth’ value set by the user in field 1414 of the spread template settings for the leg (step 702). If the second threshold criterion is satisfied, the spreader 108 will mark the working leg as suspended and transmit an order cancellation message to the electronic trading exchange system 122 in order to cancel the order for that working leg (step 704). The unfilled quantity that remained on the order for the working leg is stored in spread trade progress data 109 along with the contract of the leg and the buy/sell type of the order so that this information may be used later when the working leg is re-activated.

Whilst a working leg is marked as suspended the spreader 108 continues managing the working leg as normal according to the steps in FIG. 2, except that an order for the working leg is not transmitted to the electronic trading exchange system 122 in step 208 (if an order has not yet been created for this working leg), or if an order had previously been created for this working leg (but was then cancelled in step 702 when the order was suspended) the order for the working leg is not modified at the electronic trading exchange system 122 i.e. the spreader 108 does not transmit order modification messages to the electronic trading exchange system 122 to change the price of the order during step 208 but instead stores the new price in spread trade progress data 109.

If in step 700 the spreader 108 found that this working leg was not currently marked as activated (i.e. either no order has yet been created for this working leg or the order is suspended), the spreader 108 checks whether the first threshold criterion is satisfied, such as for example whether the absolute difference between the price to be used for the order for the working leg (as calculated in step 204) and the current highest bid or lowest offer price (depending on whether the order is a bid or offer, respectively) known from current market data of the contract for that order is less than an ‘Activate Depth’ value set by the user in field 1414 of the spread template settings for the leg (step 706). If the first threshold criterion is satisfied the spreader 108 will mark the working leg as activated (step 708). If this is the first time that the working leg has been marked as activated, the spreader 108 will transmit an order data message to the electronic trading exchange system 122 in step 208 as normal so as to create the order for the working leg. Otherwise if the working leg has previously been marked as activated the spreader 108 transmits an order data message to the electronic trading exchange system 122 in order to create a new order for the working leg in step 207 so that a new order is created for the re-activated working leg. The contract, buy/sell type, and quantity of the new order are determined from spread trade progress data 109 for the spread trade that was set in step 704, and the price of the new order will be determined by the most recent calculations performed in step 204 using recent trade data and current market data received from the electronic trading exchange system 122. The spreader 108 then continues managing the working leg as normal according to the steps in FIG. 2, modifying the new order for the working leg during step 208, if necessary.

If either the second threshold criterion is not satisfied in step 702 or the first threshold criterion is not satisfied in step 706, the spreader 108 may not deactivate or activate the order for the working leg, respectively, and will instead continue managing the working leg as normal according to the steps in FIG. 2, except that if the order for the working leg is still suspended order modification messages are not transmitted to the electronic trading exchange system 122 by the spreader 108 during step 208.

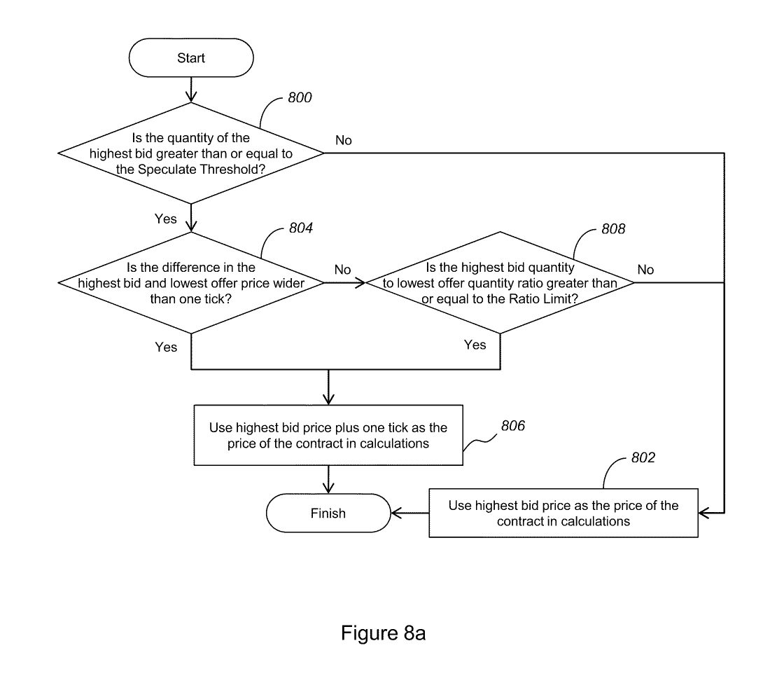

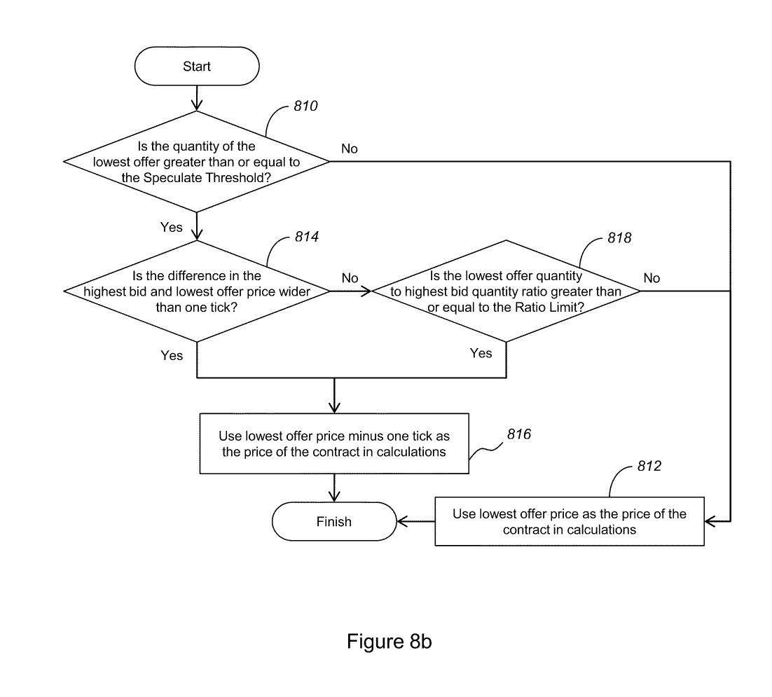

The AST terminal 100 also provides a ‘Speculate’ feature that may cause the spreader 108 to try to buy/sell the contracts of the working legs of a spread trade (i.e. the contracts ordered by the orders in the initial set of working orders for a spread trade) at more favourable prices than would be obtained if ‘Speculate’ was not activated (i.e. at a lower price if the order is a bid order, and at a higher price if the order is an offer order), if current market data and/or recent trade data indicate that the prices of the other legs of the spread may change favourably in the near future. FIGS. 8a and 8b illustrate the steps performed by the spreader component 108 when calculating the bid/offer price for the order for a working leg during step 204 in accordance with the ‘Speculate’ feature of the AST terminal 100 in order to try to buy/sell the spread at a price consistent with the spread order price (or better) by speculating that better prices than those currently bid/offered may be obtainable for the legs of the spread trade besides that working leg. The ‘Speculate’ feature is enabled for a leg of a spread trade using the setting 1420 of the spread template settings for the leg.

FIG. 8a illustrates the steps that are performed by the spreader 108 if the ‘Speculate’ feature is enabled in order to calculate the price of a working order or orders (i.e. orders or orders in the initial set of working orders) of a spread trade. After the spreader 108 has received current market data relating to the contracts in the spread trade set of contracts of a spread trade in step 202, the spreader 108 will perform the steps illustrated in FIG. 8a for those contracts. The steps in FIG. 8a will be performed for a contract provided that the current highest bid price of the contract is being used to calculate the price of an order for a working leg within the spread trade (i.e. an order in the initial set of working orders for the spread trade) when the buy/sell type of the leg of the spread trade associated with that contract is sell.

The spreader 108 first checks whether the quantity available at the current highest bid price for the contract (known from current market data received in step 202) is greater than the ‘Speculate Threshold’ set by the user in field 1419 of the spread template settings for the leg (step 800). If not, the spreader 108 will perform calculations for the prices of working orders that use the highest bid price for this contract as normal, i.e. as described in the examples for step 204 above, by using the current highest bid price for the contract where necessary in these calculations (step 802).

If in step 800 the quantity available at the current highest bid for the contract is greater than the ‘Speculate Threshold’ 1419, the spreader 108 will then check whether the difference between the highest bid price for the contract and the lowest offer price for the contract (which is also known from current market data) is greater than 1 tick (step 804). If this is the case then the spreader 108 will speculate that it may be possible to obtain a more favourable price than the current highest bid price for this contract when performing the spread trade, and the spreader 108 will thus perform calculations for the prices of working orders in the initial set of working orders for this spread trade that use the highest bid price for this contract as described in the examples for step 204 above, except that it will use the price 1 tick greater than the current highest bid for the contract instead of the current highest bid where necessary in these calculations (step 806).

If in step 804 the difference between the highest bid price for the contract and the lowest offer price for the contract was not greater than 1 tick (i.e. the difference is actually 1 tick), the spreader will check whether the ratio of the quantity available at the current highest bid for the contract to the quantity available at the lowest offer for the contract is greater than or equal to a ‘Ratio Limit’ set by the user in field 1418 of the spread template settings for the leg (step 808). If this is the case then the spreader 108 will speculate that it may be possible to obtain a more favourable price for this contract than the current highest bid price when performing the spread trade, and the spreader 108 will once again perform step 806 in order to use the price 1 tick greater than the current highest bid for the contract instead of the current highest bid where necessary when performing calculations in step 204. Note that because in step 804 it was determined that the difference between the highest bid price for the contract and the lowest offer price was only 1 tick, the price 1 tick greater than the current highest bid for the contract is in fact the lowest offer price for the contract.

If in step 808 it was determined that the ratio of the quantity available at the current highest bid for the contract to the quantity available at the lowest offer for the contract was not greater than or equal to the ‘ratio limit’, then the spreader 108 will once again perform step 802 so that the current highest bid for the contract is used when performing calculations for the prices of working orders that use the highest bid price for this contract as normal during step 204.

Similarly, FIG. 8b illustrates the steps that are performed by the spreader 108 if the ‘Speculate’ feature is enabled in order to calculate the price of a working order or orders (i.e. orders or orders in the initial set of working orders) of a spread trade. After the spreader 108 has received recent trade data and current market data relating to the contracts in the spread trade set of contracts of a spread trade in step 202, the spreader 208 will perform the steps illustrated in FIG. 8b for those contracts. The steps in FIG. 8b will be performed for a contract provided that the current lowest offer price of the contract is being used to calculate the price of the order for a working leg within the spread trade (i.e. an order in the initial set of working orders for the spread trade) when the buy/sell type of the leg of the spread trade associated with that contract is buy.

The spreader 108 first checks whether the quantity available at the current lowest offer price for the contract (known from current market data received in step 202) is greater than the ‘Speculate Threshold’ 1419 (step 810). If not, the spreader 108 will perform calculations for the prices of working orders that use the lowest offer price for this contract as normal, i.e. as described in the examples for step 204 above, by using the current lowest offer price for the contract where necessary in these calculations (step 812).

If in step 810 the quantity available at the current lowest offer for the contract is greater than the ‘Speculate Threshold’ 1419, the spreader 108 will then check whether the difference between the highest bid price for the contract (which is also known from current market data) and the lowest offer price for the contract is greater than 1 tick (step 814). If this is the case then the spreader 108 will speculate that it may be possible to obtain a more favourable price than the current lowest offer price for this contract when performing the spread trade, and the spreader 108 will thus perform calculations for the prices of working orders in the initial set of working orders for this spread trade that use the lowest offer price for this contract as described in the examples for step 204 above, except that it will use the price 1 tick lower than the current lowest offer price for the contract instead of the current lowest offer where necessary in these calculations (step 816).

If in step 814 the difference between the highest bid price for the contract and the lowest offer price for the contract was not greater than 1 tick (i.e. the difference is actually 1 tick), the spreader will check whether the ratio of the quantity available at the current lowest offer for the contract to the quantity available at the highest bid for the contract is greater than or equal to a ‘Ratio Limit’ 1418 (step 818). If this is the case then the spreader 108 will speculate that it may be possible to obtain a more favourable price for this contract than the current lowest offer price when performing the spread trade, and the spreader 108 will once again perform step 816 in order to use the price 1 tick lower than the current lowest offer price for the contract instead of the current lowest offer price where necessary when performing calculations in step 204. Note that because in step 814 it was determined that the difference between the highest bid price for the contract and the lowest offer price for the contract was only 1 tick, the price 1 tick lower than the current lowest offer price for the contract is in fact the highest bid for the contract.

If in step 818 it was determined that the ratio of the quantity available at the current lowest offer price for the contract to the quantity available at the highest bid for the contract was not greater than or equal to the ‘ratio limit’, then the spreader 108 will once again perform step 812 so that the current lowest offer for the contract is used when performing calculations for the prices of working orders that use the lowest offer price for this contract as normal during step 204.

As a result of using the ‘Speculate’ feature of the AST terminal 100 the buy/sell price of a working order in the initial set of working orders for a spread trade may be changed by a number of ticks by the spreader 108. In one embodiment of the invention the user is able to set a limit to the number of ticks by which the price of a working order is changed by the spreader 108 when the ‘Speculate’ feature is used. For example if the spreader 108 is trying to determine the price of the order for working leg A of a spread trade of buy/sell type buy involving legs A, B, C and D, where the spread template settings for the legs of the spread trade determine that the contracts for legs A and C may be bought, those for legs B and D may be sold, and the legs for contract A is a working leg, the price Wₐ at which working leg A may be bought is normally calculated (i.e. when ‘Speculate’ is not enabled) so that:

(pₐ*Wₐ)−(p_{b}*B_{b})+(p_{c}*O_{c})−(p_{d}*B_{d})≦S

is satisfied, where pₐ . . . p_{d} are the pricing ratios of legs A to D, B_{b} and B_{d} are the current highest bid prices for legs B and D respectively, obtained from current market data, O_{c} is the current lowest offer price for leg C, and S is the spread order price. With ‘Speculate’ enabled however, instead of using the current highest bid prices B_{b} and B_{d} for legs B and D respectively in the above equation, the spreader 108 may use the prices one tick greater than these current highest bid prices, depending on the current market data for the contracts of legs B and D (i.e. if step 806 is executed for each of the contracts of legs B and D). Additionally with ‘Speculate’ enabled, instead of using the current lowest offer price O_{c} for leg C in the above equation, the spreader 108 may use the price one tick less than the current offer price, depending on the current market data for the contract of leg C (i.e. if step 806 is executed for the contract of leg C). Thus the price W′ₐ at which working leg A may be bought when ‘Speculate’ is enabled may be calculated so that:

(pₐ*W′ₐ)−(p_{b}*(B_{b}+1))+(p_{c}*(O_{c}−1))−(p_{d}*(B_{d}+1))≦S

is satisfied. Depending on the values of the other variables in the above equation, the price W′ₐ at which working leg A may be bought may be several ticks more than Wₐ. The user may wish to limit the difference between W′ₐ and Wₐ by setting an appropriate limit in the spread template settings for leg A, such that the spreader will limit W′ₐ according to the equation:

abs(W′ₐ−Wₐ)≦Lₛ

where abs(X) represents the absolute value of the variable X, and Lₛ is the value of the limit set by the user.

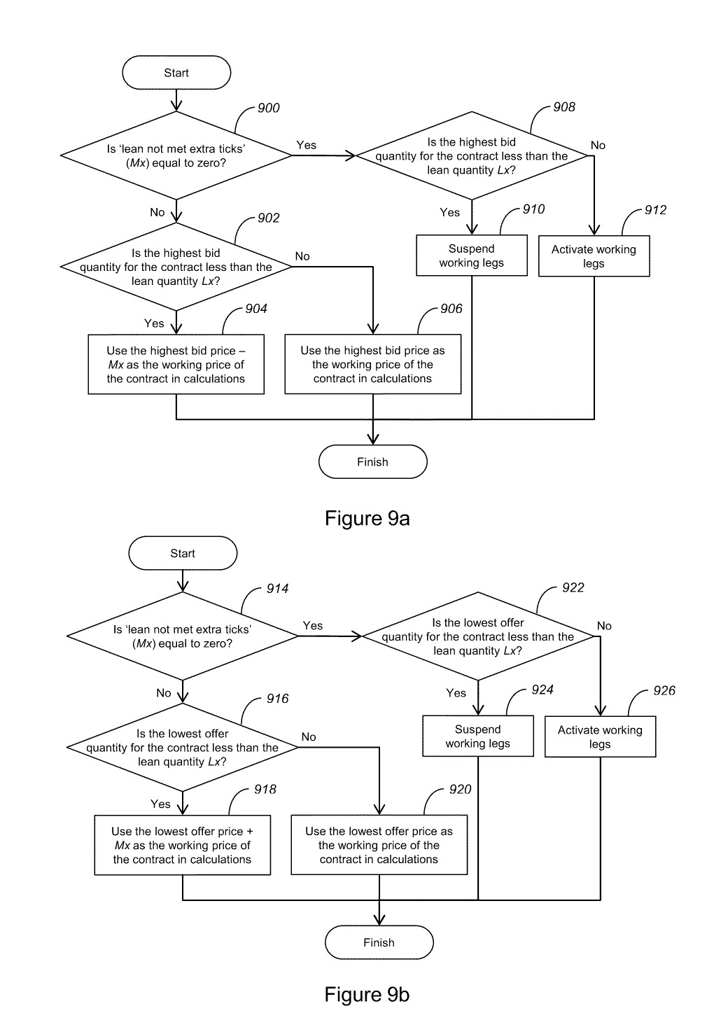

The AST terminal 100 also provides a ‘Lean’ feature that may be used to avoid the spreader 108 from to trying to buy/sell the contracts of the working legs of a spread trade (i.e. the contracts ordered by the orders in the initial set of working orders for a spread trade), if current market data and/or recent trade data indicate that prices for the contracts in the spread trade set of contracts for the spread trade may change unfavourably in the near future. FIGS. 9a and 9b illustrate the steps performed by the spreader component 108 when calculating the bid/offer price for the order for a working leg during step 204 in accordance with the ‘Lean’ feature of the AST terminal 100 in order to try to buy/sell the spread at a price consistent with the spread order price by detecting that the current bid or offer prices may not be achievable for the contracts in the spread trade set of contracts for the spread trade.

FIG. 9a illustrates the steps that are performed by the spreader 108 when the ‘Lean’ feature is enabled for a leg of a spread trade, where the spreader 108 is leaning on the current highest bid price of the contract associated with the leg in order to calculate the price of a working order (or orders). After the spreader 108 has received recent trade data and current market data relating to the spread trade set of contracts of a spread trade in step 202, the spreader 108 will perform the steps illustrated in FIG. 9a for each contract in the spread trade set of contracts for the spread trade whose current highest bid price is being used to calculate the price of the order for a working leg within the spread trade (i.e. an order in the initial set of working orders for the spread trade) when the buy/sell type of that working leg is sell.

The spreader 108 first checks whether the ‘Lean Not Met Extra Ticks’ parameter Mₓ set by the user in field 1424 of the spread template settings for the leg is equal to zero (step 900). If Mₓ is not zero the spreader 108 will then check whether the quantity available at the current highest bid for the contract (known from current market data received in step 202) is less than the ‘Lean Quantity’ Lₓ set by the user in field 1422 of the spread template settings for the leg (step 902). If this is the case the spreader 108 will detect that it may not be possible for the hedger 110 to obtain the current highest bid price for this contract if a working order in the initial set of working orders for this spread trade is filled, so the spreader 108 may thus perform calculations for the prices of working orders in the initial set of working orders for this spread trade that use the highest bid price for this contract as described in the examples for step 204 above, except that it will use the price Mₓ ticks lower than the current highest bid for the contract instead of the current highest bid where necessary in these calculations (step 904).

If in step 902 the quantity available at the current highest bid for the contract is not less than the ‘Lean Quantity’ L, 1422, the spreader 108 will perform calculations for the prices of working orders that use the highest bid price for this contract as normal, i.e. as described in the examples for step 204 above, by using the current highest bid price for the contract where necessary in these calculations (step 906).

If in step 900 the ‘Lean Not Met Extra Ticks’ parameter Mₓ 1424 is equal to zero, the spreader once again checks whether the quantity available at the current highest bid for the contract (known from current market data received in step 202) is less than the ‘Lean Quantity’ Lₓ 1422 set for this leg by the user (step 908). If this is the case the spreader 108 will suspend the orders for the working legs of this spread trade, i.e. it will mark each of them as suspended in spread trade progress data 109 for the spread trade and, if these orders for the working legs were not already marked as suspended in spread trade progress data 109 for the spread trade, the spreader 108 will transmit for each order an order cancellation message to the electronic trading exchange system 122 in order to cancel the order (step 910). By doing this the spreader 108 has cancelled the orders at the electronic trading exchange system 122 that form the initial set of working orders for the spread trade. The spreader 108 then continues managing the working legs as normal according to the steps in FIG. 2, except that these orders for the working legs are not modified at the electronic trading exchange system 122 by the spreader 108 i.e. order modification messages are not transmitted to the system 122 for the working legs during step 208.

If in step 908 the quantity available at the current highest bid for the contract is not less than the ‘Lean Quantity’ L, 1422, the spreader 108 will activate the orders for the working legs of this spread trade, i.e. it will mark each of them as activated in spread trade progress data 109 for the spread trade and, if the orders for the working legs were not already marked as activated in spread trade progress data 109 for the spread trade, the spreader 108 will transmit for each working leg an order data message to the electronic trading exchange system 122 in order to create a new order for the working leg (step 912). These orders will form the new initial set of working orders for the spread trade. The contract, buy/sell type, and quantity of the new order for each working leg will be the same as that of the order for that leg that was previously cancelled in step 910, and the price of the new order will be determined by the most recent calculations performed in step 204 using recent trade data and current market data received from the electronic trading exchange system 122. The spreader 108 then continues managing the working legs as normal according to the steps in FIG. 2, modifying the new orders for the working legs during step 208, if necessary.

FIG. 9b illustrates the steps that are performed by the spreader 108 when the ‘Lean’ feature is enabled for a leg of a spread trade, where the spreader 108 is leaning on the current lowest offer price of the contract associated with the leg in order to calculate the price of a working order (or orders). After the spreader 108 has received recent trade data and current market data relating to the spread trade set of contracts of a spread trade in step 202, the spreader 108 will perform the steps illustrated in FIG. 9b for each contract in the spread trade set of contracts for the spread trade whose current lowest offer price is being used to calculate the price of the order for a working leg within the spread trade(i.e. an order in the initial set of working orders for the spread trade) when the buy/sell type of that working leg is sell.

The spreader 108 first checks whether the ‘Lean Not Met Extra Ticks’ parameter Mₓ 1424 is equal to zero (step 914). If Mₓ is not zero the spreader 108 will then check whether the quantity available at the current lowest offer for the contract (known from current market data received in step 202) is less than the ‘Lean Quantity’ Lₓ 1422 (step 916). If this is the case the spreader 108 will detect that it may not be possible to for the hedger 110 obtain the current lowest offer price for this contract if a working order in the initial set of working orders for this spread trade is filled, so the spreader 108 may thus perform calculations for the prices of working orders in the initial set of working orders for this spread trade that use the lowest offer price for this contract as described in the examples for step 204 above, except that it will use the price Mₓ ticks higher than the current lowest offer for the contract instead of the current lowest offer where necessary in these calculations (step 918).

If in step 916 the quantity available at the current lowest offer for the contract is not less than the ‘Lean Quantity’ Lₓ 1422, the spreader 108 will perform calculations for the prices of working orders that use the lowest offer price for this contract as normal, i.e. as described in the examples for step 204 above, by using the current lowest offer price for the contract where necessary in these calculations (step 920).

If in step 914 the ‘Lean Not Met Extra Ticks’ parameter Mₓ 1424 set for this leg by the user is equal to zero, the spreader once again checks whether the quantity available at the current lowest offer for the contract (known from current market data received in step 202) is less than the ‘Lean Quantity’ Lₓ 1422 set for this leg by the user (step 922). If this is the case the spreader 108 will suspend the orders for the working legs of this spread trade, i.e. it will mark each of them as suspended in spread trade progress data 109 for the spread trade and, if these orders for the working legs were not already marked as suspended in spread trade progress data 109 for the spread trade, the spreader 108 will transmit for each order an order cancellation message to the electronic trading exchange system 122 in order to cancel the order (step 924). By doing this the spreader 108 has cancelled the orders at the electronic trading exchange system 122 that form the initial set of working orders for the spread trade. The spreader 108 then continues managing the working legs as normal according to the steps in FIG. 2, except that the orders for the working legs are not modified at the electronic trading exchange system 122 by the spreader 108, i.e. order modification messages are not transmitted to the system 122 for the working legs during step 208.

If in step 922 the quantity available at the current lowest offer for the contract is not less than the ‘Lean Quantity’ Lₓ 1422, the spreader 108 will activate the orders for the working legs of this spread trade, i.e. it will mark each of them as activated in spread trade progress data 109 for the spread trade and, if the orders for the working legs were not already marked as activated in spread trade progress data 109 for the spread trade, the spreader 108 will transmit for each working leg an order data message to the electronic trading exchange system 122 in order to create a new order for the working leg (step 926). These orders will form the new initial set of working orders for the spread trade. The contract, buy/sell type, and quantity of the new order for each working leg will be the same as that of the order for that leg that was previously cancelled in step 924, and the price of the new order will be determined by the most recent calculations performed in step 204 using recent trade data and current market data received from the electronic trading exchange system 122. The spreader 108 then continues managing the working legs as normal according to the steps in FIG. 2, modifying the new orders for the working legs during step 208, if necessary.

As an alternative to creating a ticket for a standard spread trade, the user is also able to create a ticket for a ‘Manual Order’ from a spread template as summarised in step 142 of FIG. 1b. A Manual Order can be used to buy/sell a user-selected leg of a spread template (corresponding to one of the contracts in the spread trade set of contracts) at a user-selected price. Once the contract for the selected leg has been bought/sold, the hedger 110 will be instructed to execute orders for the remaining legs of the spread trade using the current hedger 110 settings defined in the spread template. Thus a Manual Order causes the AST terminal 100 to buy/sell the legs of a spread (i.e. the contracts in the spread trade set of contracts) when the contract of one of the legs of the spread has reached a fixed price chosen by the user (which could for example be a price that the user considers to be favourable for that leg in comparison to the prices of the other contracts in the spread trade set of contracts).

FIG. 17 shows an exemplary screenshot of a ticket window for a ‘Manual Order’. In the ticket window the user can select a single leg from a list of the legs of the spread template 1700, the price 1710 at which to buy/sell the selected leg 1702, and a quantity 1712 of that leg to buy/sell. The user is also provided with a buy button 1714 and a sell button 1716. By clicking on one of these buttons the user will activate a new ‘Manual Order’ based on the spread template and the settings chosen.

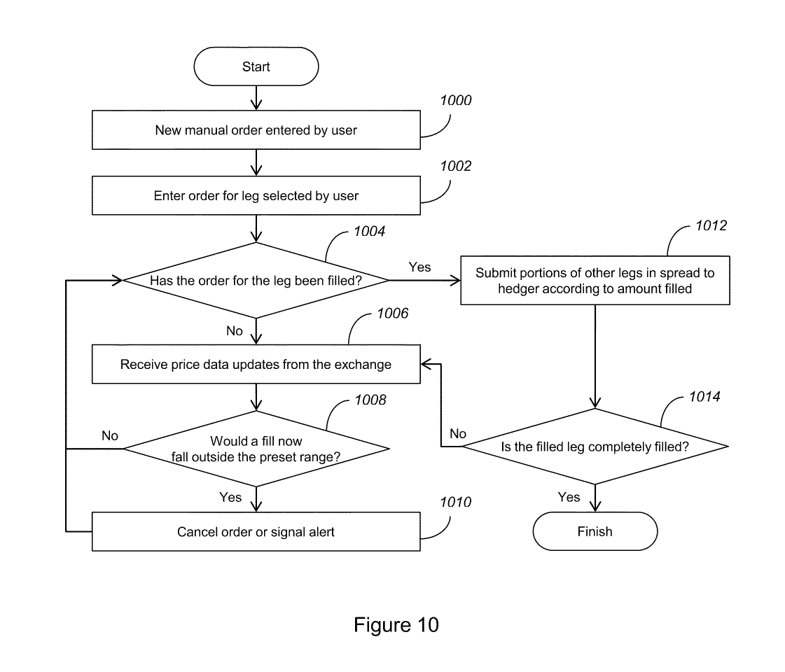

FIG. 10 illustrates the steps performed by the spreader 108 in order to execute a ‘Manual Order’. When the user activates a new spread trade by clicking on either the buy button 1714 or the sell button 1716 in the ‘Manual Order’ ticket window, the spreader component 108 gathers the information entered by the user and instructs the graphical user interface component 112 to disable the buy button 1714 and sell button 1716 (step 1000). The spreader 108 then instructs the exchange interface 106 to transmit an order data message to the electronic trading exchange system 122 in order to create a new order for the contract of the leg 1702 selected by the user in the ‘Manual Order’ ticket window, where the price and the quantity of the order are determined according to the settings 1710 and 1712 respectively, and the buy/sell type of the order is determined according to the button pressed (step 1002). This order created by the spreader 108 forms the only order in the initial set of working orders for the spread trade corresponding to the ‘Manual Order’. The spreader 108 then determines the buy/sell type of the spread trade to which the created order will be linked as follows. If the buy/sell type of the order is the same as the buy/sell type setting in the spread template for the leg to which the order belongs, the buy/sell type of the spread trade is type buy. Otherwise if the buy/sell type of the order is the opposite of the buy/sell type setting in the spread template for the leg to which the order belongs, the buy/sell type of the spread trade is type sell. The above information relating to this order is stored by the spreader 108 in spread trade progress data 109 for the spread trade for the ‘Manual Order’.

The spreader 108 then checks whether the order created in step 1002 has been filled at the electronic trading exchange system 122, by checking whether the exchange interface 106 has received a fill confirmation message for the order from the electronic trading exchange system 122 (step 1004). If the order has not been filled the spreader component 108 then uses the exchange interface 106 to request and receive from the electronic trading exchange system 122 recent trade data and current market data relating to the contracts in the spread trade set of contracts for the spread trade on which the Manual Order is based and stores this information in spread trade progress data 109 for the spread trade (step 1006).

The spreader 108 may then use the current market data received from the electronic trading exchange system 122 in step 1006 to calculate the spread order price and determine whether the spread order price of the spread would fall outside a user-set range if the order created in step 1002 were filled at the user set price and orders for the other legs of the spread trade were filled at the current price levels of their respective contracts (step 1008). If the spread trade is of type buy, then the spread order price of the spread trade will fall outside of the user-set range if the current market data determines that the spread order price is greater than a ‘Buy Limit’ set by the user in field 1720 on the Manual Order ticket. If the spread trade is of type sell, then the spread order price of the spread trade will fall outside of the user-set range if the current market data determines that the spread order price is less than a ‘Sell Limit’ set by the user in field 1718 on the Manual Order ticket. Depending on the ‘Action’ setting set by the user in field 1722 of the Manual Order ticket, the spreader 108 may do nothing, display a warning message to the user, or transmit an order cancellation message to the electronic trading exchange system 122 in order to cancel the order created in step 1002 (step 1010). If the order is cancelled the spreader 108 has finished managing this Manual Order, otherwise, or if the test in step 1008 was not satisfied, the spreader 108 returns to step 1004.

If in step 1004 it was determined that the order created in step 1002 had been filled at the electronic trading exchange system 122, the spreader 108 will record this in spread trade progress data 109 for the spread trade and request that the hedger component 110 execute a hedge order for each of the legs of the spread trade except the leg corresponding to the order that has been filled (i.e. the selected leg 1702) (step 1012). These hedge orders that are executed by the hedger 110 in step 1012 form the completing set of orders for the spread trade. The spreader component 108 informs the hedger component 110 of the spread template to which the new orders relate, the identifiers of the contracts for the legs for which orders may be submitted, and, as is described below, the spreader component 108 informs the hedger component 110 of the buy/sell types to use for each leg and the quantity to order for each leg.

The spreader 108 determines the buy/sell type of each leg that is created in step 1012 as follows. If the buy/sell type of the spread trade is set to buy, each leg of the spread will be bought or sold according to the buy/sell type parameter of each leg, as set by the user in the spread template. If the buy/sell type of the new spread trade is set to sell, each leg of the spread will be bought or sold using the opposite of the buy/sell type set in the for each leg in the spread template.

The hedger component 110 calculates the prices of each order to be entered according to the hedger settings and according to recent trade data and current market data it obtains from the electronic trading exchange interface 122, and then manages the hedge orders as normal as illustrated in the steps shown in FIG. 3 described above in order to complete the spread trade.

In step 1004 the fill confirmation message received by the exchange interface 106 will indicate the quantity filled on the order created in step 1002. The hedger component 110 may thus be instructed to create hedge orders for the other legs of the spread trade with quantities ordered corresponding to the matched quantity of the filled leg. The spreader component 108 calculates the quantity qₓ required for the hedge order for leg X according to:

qₓ=Fₐ/tₐ*tₓ

where Fₐ is the filled quantity of the filled order (belonging to the selected leg A 1702) and tₐ and tₓ are the trading ratios of the legs A and X, respectively. The quantity value qₓ is then communicated to the hedger 110 by the spreader 108 along with the other information mentioned above when a new hedge order is requested.

The spreader 108 then checks whether the order created in step 1002 has been completely filled (step 1014). If the order has not been completely filled the spreader 108 returns to step 1006 in order to continue managing this Manual Order. Otherwise if the order has been completely filled the spreader 108 has finished managing this spread trade and can instruct the graphical user interface component 112 to update information relating to the spread trade listed in the spread order list window, as exemplified by the screen shown in FIG. 19, and can also instruct the graphical user interface component 112 to enable the buy button 1714 and sell button 1716 on the ‘Manual Order’ ticket.

As an alternative to creating a ticket for a standard spread trade, the user is also able to create a ticket for an ‘At Best Spread Order’ from a spread template as summarised in step 142 of FIG. 1b. An ‘At Best Spread Order’ can be used to create a spread trade to buy/sell each of the contracts in the spread trade set of contracts defined in a spread template at the best price currently available for each contract. Thus a spread trade created using an ‘At Best Spread Order’ can buy/sell the contracts relating to a spread at current prices, allowing the user to take advantage of the current spread price if he feels it is favourable.

FIG. 18 shows an exemplary screenshot of a ticket window for an ‘At Best Spread Order’. Market values for the spread trade are displayed in the ticket window for the spread trade, indicating the lowest offer price 1800 on the market for the spread trade, the highest bid price 1802 and the price at which the spread trade was traded most recently 1804. The graphical user interface component 112 regularly uses the exchange interface 106 to request and receive recent trade data and current market data from the electronic trading exchange system 122 relating to the contracts of the legs of the spread trade template to which a ticket corresponds, and then updates the market values shown on the ticket (i.e. 1800 to 1804) using this data, in the same way as for a ticket for a standard spread trade as summarised above. The user can set a ‘quantity multiplier’ (in the entry fields 1806 or 1812 as appropriate) to determine how much of the spread trade to buy/sell.

In the ‘At Best Spread Order’ ticket window illustrated in FIG. 18 the user is provided with a ‘buy’ spread trade button 1808 and a ‘sell’ spread trade button 1814. By clicking on one of these buttons the user will activate a new spread trade based on the spread trade template and the settings chosen. If the user activates a new spread trade by pressing on the ‘buy’ spread trade button 1808, the buy/sell type of the new spread trade is set to buy, and similarly if the user activates a new spread trade by pressing on the ‘sell’ spread trade button 1814, the buy/sell type of the new spread trade is set to sell.

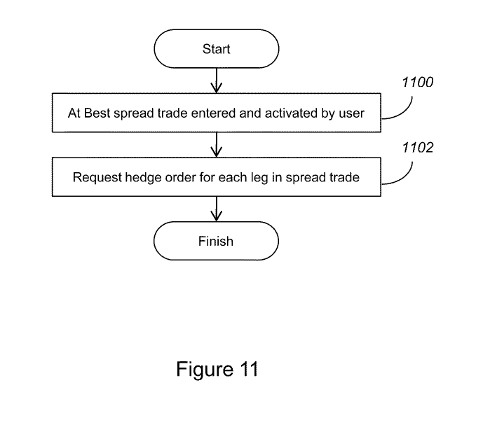

FIG. 11 illustrates the steps performed by the spreader 108 in order to execute a spread trade created using an ‘At Best Spread Order’ ticket. The user activates a new spread trade by clicking on either the buy or sell button 1808 or 1814 in the ‘At Best Spread Order’ ticket window (step 1100). The spreader 108 gathers the information entered by the user and then instructs the hedger 110 to execute a hedge order for all of the legs of the spread trade (step 1102). These hedge orders that are executed by the hedger 110 form the completing set of orders for the spread trade. Each hedge order in the completing set of orders that is created for the spread trade uses the same buy/sell type defined in the spread template settings for that leg if the buy/sell type of the spread trade is type buy, and the opposite buy/sell type to the spread template setting for that leg if the buy/sell type of the spread trade is type sell. For each leg X the quantity tₓ*Q of the leg will be bought/sold, where tₓ is the trade ratio of the leg X (stored in the spread trade template) and Q is the ‘quantity multiplier’ of the spread that may be bought (e.g. as set by the user in entry fields 1806 or 1812). The hedger component 110 calculates the prices of each order to be entered according to the hedger settings and according to recent trade data and current market data it obtains from the electronic trading exchange interface 122, and then manages the hedge orders as normal as illustrated in the steps shown in FIG. 3 described above in order to complete the spread trade.

The above embodiments are to be understood as illustrative examples of the invention. Further embodiments of the invention are envisaged as follows.

Alternative embodiments of the invention are envisaged wherein the hedger 110 may not calculate the price to use for a new hedge order when ‘Standard Hedging’ is used in step 304 when executing a new hedge order according to the steps in FIG. 3, but may instead use a ‘market order’ to create an order for the hedge order, if it is necessary to create a new order for the hedge order in step 308. A ‘market order’ is an order that does not contain a price value. When the electronic exchange trading system 122 receives a market order it will match that order at the best price available for that order's contract and buy/sell type, hence the hedger 110 may avoid receiving price data updates from the electronic trading exchange system 122 in step 302 and calculating the bid/offer price of a hedge order in step 304 in order to gain a processing advantage and execute a hedge order immediately, if necessary.

Alternative embodiments of the invention are envisaged wherein the user may not mark any of the legs of a spread template as working legs in order to create a spread template for a ‘No Working Legs’ order. When a spread trade based on this spread template is executed the spreader 108 may not create an initial set of working orders, and instead orders forming a completing set of orders for all the legs of the spread trade are executed by the hedger 110. In this case in step 204 the spreader 108 immediately instructs the hedger 110 to execute a hedge order for every leg of the spread trade (i.e. one order for every contract in the spread trade set of contracts) using the buy/sell types and quantities determined in step 200. The spreader 108 may not create an initial set of working orders and may not proceed with the remaining steps following step 204 in FIG. 2, but instead may finish managing this new spread trade at this point. The hedge orders requested by the spreader 108 and executed by the hedger 110 form the completing set of orders for the spread trade, and are managed by the hedger 110 as normal according to the steps shown in FIG. 3. This embodiment may used in combination with any of the features described above.

Alternative embodiments of the invention are envisaged wherein, during management of a new spread trade according to the steps in FIG. 2, the spreader 108 may not create working orders forming an initial set of working orders for the spread trade if in step 204 it detects that the calculated buy/sell prices that would be used for these working orders would be immediately satisfied under current market conditions known from recent trade data and current market data, in order to create a ‘Monitor Only’ order. In this case in step 204 the spreader 108 immediately instructs the hedger 110 to execute a hedge order for every leg of the spread trade (i.e. one order for every contract in the spread trade set of contracts) using the buy/sell types and quantities determined in step 200. The spreader 108 may not create an initial set of working orders and may not proceed with the remaining steps following step 204 in FIG. 2, but instead may finish managing this new spread trade at this point. The hedge orders requested by the spreader 108 and executed by the hedger 110 form the completing set of orders for the spread trade, and are managed by the hedger 110 as normal according to the steps shown in FIG. 3. This embodiment may used in combination with any of the features described above.

Alternative embodiments of the invention are envisaged wherein the exchange interface 106, spreader 108 and hedger 110 are not located within same terminal or general purpose computer as the graphical user interface 112. In this case the graphical user interface 112 may be located at a remote terminal at the location of a user that may also comprise the video output component 116 and video display 118 to display windows, tickets, etc. generated by the graphical user interface 112 to the user. The remote terminal also comprises of a network interface with which to communicate with the exchange interface 106, spreader 108 and hedger 110 that are located at an Automated Spread Trading (AST) server. The AST server in this embodiment includes a microprocessor 102 that processes instructions in the form of electronic signals stored in a random access memory (RAM) that have been loaded from a computer-readable medium such as a hard disk. These instructions are in the form of computer software, in the form of one or more programs that implement the exchange interface 106, the spreader component 108, and the hedger component 110. The AST server comprises RAM in which spread trade progress data 109 is stored as well as a network interface that allows the exchange interface 106 to communicate with the electronic trading exchange system 122, and allows the exchange interface 106, spreader 108 and hedger 110 to communicate with the graphical user interface 112 at the remote terminal. The AST server may be placed within a communications network such as a private communications network that is closely coupled to the electronic trading exchange system 122 or a plurality of such electronic trading exchange systems, in order for the AST server to be able to transmit and receive information in the form of current market data, recent trade data and/or messages from the electronic trading exchange system 122 with lower latency than would be possible from the remote terminal.

Alternative embodiments of the invention are envisaged wherein the spreader component 108 and hedger component 110 are not located within the same terminal or general purpose computer. In this case spread trade progress data 109 may be held in RAM at the terminal or general purpose computer where the spreader 108 is located, or where the hedger 110 is located, or may be held in both of these terminals or general purpose computers, or may be held in a separate terminal or general purpose computer. The spreader 108 and hedger 109 may co-operate in order to access and maintain spread trade progress data 109, and/or they may transmit data between them in order to access and maintain this data. Additionally the graphical user interface component 112 may be located in the same terminal as either the spreader 108 or hedger 110 or may be located in a separate terminal or general purpose computer. Additionally the exchange interface 106 may be located in the same terminal as the spreader 108 or hedger 110 or in a separate terminal or general purpose computer or there may be a separate exchange interface 106 for both the spreader 108 and hedger that may be located in the same terminal or general purpose computer as the spreader 108 or hedger 110 respectively. In each of these cases the separate terminals or general purpose computers each comprise a network interface with which to communicate with the components located at separate terminals via a communications network or a plurality of such communications networks.

Alternative embodiments of the invention are envisaged wherein the spreader component 108 and/or hedger component 110 may be partially or entirely implemented in specialised hardware circuitry such as for example an Application-Specific Integrated Circuit (ASIC) or a Field-Programmable Gate Array (FPGA) located within the AST terminal 100, rather than entirely processed by the microprocessor 102. These embodiments allow the AST terminal 100 to quickly process information received in the form of current market data, recent trade data and/or messages from the electronic trading exchange system 122 and then respond to this information as soon as possible, in order to gain a processing advantage over other terminals 128.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A computer-implemented method for generating and transmitting, via a data communications network, messages related to a spread trade, said method comprising:
receiving from a user a selection of a spread trade indicative of a set of trading contracts defined in relation to the spread trade;
transmitting to at least one electronic trading exchange a first set of one or more messages, including one or more order messages relating to said user selection such that an initial set of one or more working orders, each corresponding to one of the trading contracts defined in relation to the selected spread trade, are rendered operative in the at least one electronic trading exchange;
receiving from the at least one electronic trading exchange a first fill confirmation message confirming the at least partial completion of a first working order in said initial set of working orders;
receiving from an electronic trading exchange current market data indicating quantities of current bids and/or offers in relation to one or more of the trading contracts defined in relation to the spread trade;
in response to receiving said first fill confirmation message, transmitting to at least one of the at least one electronic trading exchanges a second set of one or more messages, including one or more order messages and/or order modification messages, relating to said user selection such that a completing set of one or more working orders, each corresponding to one of the trading contracts defined in relation to the selected spread trade, are rendered operative in the at least one of the at least one electronic trading exchange, the completing set of working orders relating to one or more trading contracts including one or more trading contracts other than the trading contract in relation to which said first fill confirmation message has been received,
wherein said method comprises reducing a quantity on order at a given price level from a first non-zero quantity to a second non-zero quantity, for a trading contract in said completing set of one or more working orders on the basis of at least one bid or offer quantity in said current market data.

2. A method according to claim 1, wherein said reduction in quantity is determined at least in part on the basis of a user-defined relationship.

3. A method according to claim 1, wherein said method comprises a plurality of order messages and/or order modification messages in said second set of messages to set up a plurality of working orders at said given price level, and said reduction in quantity is achieved by sending an order modification message or order cancellation message to selectively alter at least one of said plurality of working orders whilst maintaining at least one other of said plurality of working orders at said given price level.

4. A computer-implemented method for generating and transmitting, via a data communications network, messages related to a spread trade, said method comprising:
receiving from a user a first selection of a spread trade indicative of a set of trading contracts defined in relation to a first spread trade;
transmitting to at least one electronic trading exchange a first set of one or more messages, including one or more order messages relating to said first selection such that an initial set of one or more working orders, each corresponding to one of the trading contracts defined in relation to said first spread trade are rendered operative in the at least one electronic trading exchange;
receiving from the at least one electronic trading exchange a first fill confirmation message confirming the at least partial completion of a first working order in said initial set of working orders;
in response to receiving said first fill confirmation message, transmitting to at least one of the at least one electronic trading exchanges a second set of one or more messages, including one or more order messages and/or order modification messages, relating to said first selection such that a completing set of one or more working orders, each corresponding to one of the trading contracts defined in relation to said first spread trade, are rendered operative in the at least one of the at least one electronic trading exchanges, the completing set of working orders relating to one or more trading contracts including one or more trading contracts other than the trading contract in relation to which said first fill confirmation message has been received,
receiving a second selection of a spread trade indicative of a set of trading contracts defined in relation to a second spread trade, and processing said second selection, said processing comprising transmitting to the at least one electronic trading exchange an order cancellation message or an order modification message, such that a first completing working order in said completing set of working orders is cancelled or modified in the at least one electronic trading exchange in response to detecting a correspondence between a trading contract being processed in said second selection and a trading contract being processed in said first selection.

5. A method according to claim 4, comprising transmitting to the at least one of the at least one electronic trading exchange a first order message relating to said second selection such that a working order, corresponding to one of the trading contracts defined in relation to said first spread trade, is rendered operative in the at least one electronic trading exchange,
wherein said first order message and order messages in said first set of one or more messages comprise quantity data, and said quantity data of said first order message is determined at least in part on the basis of the quantity data in the message in said first set of one or more messages relating to said first completing working order that is cancelled or modified.

6. A method according to claim 5, wherein said first order message and said first set of one or more messages comprise a buy/sell type, and wherein the buy/sell type of said first order message is of the opposite type to that of the message in said first set of one or more messages relating to said first completing working orders that is cancelled or modified.

7. A method according to claim 4, wherein said first set of one or more messages comprise a price value and said step of processing said second selection comprises recording a filled price value for said first completing working order that is cancelled or modified, wherein said filled price value is determined at least in part on the basis of the price value in the message in said first set of one or more messages relating to said first completing working order that is cancelled or modified.

8. A computer-implemented method for generating and transmitting, via a data communications network, messages related to a spread trade, said method comprising:
receiving from a user a selection of a spread trade indicative of a set of trading contracts defined in relation to the spread trade;
receiving from an electronic trading exchange first price data indicating prices of current bids, offers and/or trades in relation to one or more of the trading contracts defined in relation to the spread trade;
in response to detecting that said first price data indicates that said prices of current bids, offers and/or trades satisfies a first threshold criterion, transmitting to at least one electronic trading exchange a first set of one or more messages, including one or more order messages relating to said user selection such that an initial set of one or more working orders, each corresponding to one of the trading contracts defined in relation to the selected spread trade are rendered operative in the at least one electronic trading exchange.

9. A method according to claim 8, comprising:
receiving from an electronic trading exchange second price data indicating prices of current bids, offers and/or trades in relation to one or more of the trading contracts defined in relation to the spread trade;
in response to detecting that said second price data indicates that said prices of current bids, offers and/or trades satisfies a second threshold criterion, transmitting to the at least one electronic trading exchange a second set of one or more messages, including one or more cancellation messages relating to said user selection such that the initial set of one or more working orders, each corresponding to one of the trading contracts defined in relation to the selected spread trade, are rendered inoperative in the at least one electronic trading exchange.

10. A method according to claim 9, comprising:
receiving from an electronic trading exchange third price data indicating prices of current bids, offers and/or trades in relation to one or more of the trading contracts defined in relation to the spread trade; and
in response to receiving said second price data, in response to detecting that said third price data indicates that said prices of current bids, offers and/or trades satisfies a first threshold criterion, transmitting to at least one electronic trading exchange a third set of one or more messages, including one or more order messages relating to said user selection such that an initial set of one or more working orders, each corresponding to one of the trading contracts defined in relation to the selected spread trade are rendered operative in the at least one electronic trading exchange.

11. A computer-implemented method for generating and transmitting, via a data communications network, messages related to a spread trade, said method comprising:
receiving from a user a selection of a spread trade indicative of a set of trading contracts defined in relation to the spread trade;
transmitting to at least one electronic trading exchange a first set of one or more messages, including one or more order messages relating to said user selection such that an initial set of one or more working orders, each corresponding to one of the trading contracts defined in relation to the selected spread trade are rendered operative in the at least one electronic trading exchange;
receiving from the at least one electronic trading exchange a first fill confirmation message confirming the at least partial completion of a first working order in said initial set of working orders;
in response to receiving said first fill confirmation message, transmitting to at least one of the at least one electronic trading exchanges a second set of one or more messages, including one or more order modification messages, relating to said user selection such that a completing set of one or more working orders, each corresponding to one of the trading contracts defined in relation to the selected spread trade, are rendered operative in the at least one of the at least one electronic trading exchanges, the order modification messages relating to said initial set of working orders.

12. A method according to claim 11, wherein said second set of one or more messages comprise price data, said method comprising:
receiving from an electronic trading exchange first price data indicating prices of current bids, offers and/or trades in relation to one or more of the trading contracts defined in relation to the spread trade; and
determining the price data of one or more messages in said second set of one more messages at least in part on the basis of said first price data.

13. A method according to claim 11, wherein said first fill confirmation message confirms the partial completion of a first working order in said initial set of working orders, said method comprising:
receiving from the at least one electronic trading exchange a first order modification confirmation message confirming the modification of an order according to an order modification message in said second set of one or more order messages, said order modification message and said order modification confirmation message corresponding to a first trading contract defined in relation to the selected spread trade; and
transmitting to at least one electronic trading exchange a first order message relating to said user selection such that an order in said initial set of more than one working orders corresponding to said first trading contract defined in relation to the selected spread trade is rendered operative in the at least one electronic trading exchange.

14. A computer-implemented method for generating and transmitting, via a data communications network, messages related to a spread trade, said method comprising:
receiving from a user a selection of a spread trade indicative of a set of trading contracts defined in relation to the spread trade;
transmitting to at least one electronic trading exchange a first set of one or more messages, including one or more order messages relating to said user selection such that an initial set of one or more working orders, each corresponding to one of the trading contracts defined in relation to the selected spread trade, are rendered operative in the at least one electronic trading exchange;
receiving from the at least one electronic trading exchange a first fill confirmation message confirming the at least partial completion of a first working order in said initial set of working orders;
receiving from an electronic trading exchange current market data indicating quantities of current bids and/or offers in relation to one or more of the trading contracts defined in relation to the spread trade, the current market data including quantities of current bids and/or offers at a plurality of different price levels including a best price level and an off-best price level;
in response to receiving said first fill confirmation message, transmitting to at least one of the at least one electronic trading exchanges a second set of one or more messages, including one or more order messages and/or order modification messages, relating to said user selection such that a completing set of one or more working orders, each corresponding to one of the trading contracts defined in relation to the selected spread trade, are rendered operative in the at least one of the at least one electronic trading exchange, the completing set of working orders relating to one or more trading contracts including one or more trading contracts other than the trading contract in relation to which said first fill confirmation message has been received,
wherein a working order for a trading contract in said completing set of one or more working orders is controlled, by the transmission of messages to at least one of the at least one electronic trading exchanges, at least partly on the basis of both a quantity at said best price level and at a quantity at an off-best price level for said trading contract.

15. A computer-implemented method according to claim 14, wherein said current market data price levels are arranged in regularly-spaced intervals and said off-best price level is arranged a single interval away from said best price level.

16. A computer-implemented method for generating and transmitting, via a data communications network, messages related to a spread trade, said method comprising:
receiving from a user:
a selection of a spread trade indicative of a set of trading contracts defined in relation to the selected spread trade;
a selection of a trading contract, said selected trading contract being one of the set of trading contracts defined in relation to the selected spread trade
an indication of a price level at which said selected trading contract is to be traded;
transmitting to at least one electronic trading exchange a message relating to said selected trading contract, said message rendering operative, in the at least one electronic trading exchange, an order relating to said selected trading contract at the indicated price level;
receiving from the at least one electronic trading exchange a first fill confirmation message confirming the at least partial completion of said order relating to said selected trading contract;
transmitting to at least one of the at least one electronic trading exchanges a set of one or more messages, including one or more order messages and/or order modification messages, relating to said selected spread trade such that a completing set of one or more working orders, each corresponding to one of the trading contracts defined in relation to the selected spread trade, are rendered operative in the at least one of the at least one electronic trading exchanges, the completing set of working orders relating to one or more trading contracts including one or more trading contracts other than said selected trading contract.
